(19) United States
(12) Patent Application Publication
(10) Pub. No.: US 2024/0090546 A1
(43) Pub. Date: Mar. 21, 2024

(54) COMPOSITIONS COMPRISING AND METHODS OF USING 1,3-PROPANEDIOL, TO IMPROVE SWEETNESS AND/OR REDUCE BITTERNESS OF SWEETENERS

(71) Applicant: Primient Covation LLC, Loudon, TN (US)

(72) Inventors: Sean L. Gahan, Knoxville, TN (US); Alexander H. Woo, Chicago, IL (US)

(73) Assignee: Primient Covation LLC, Loudon, TN (US)

(21) Appl. No.: 18/368,599

(22) Filed: Sep. 15, 2023

Related U.S. Application Data
(60) Provisional application No. 63/407,250, filed on Sep. 16, 2022.

(51) Int. Cl. A23L 27/30; A23L 27/00; A23L 27/10; A23L 29/00

(52) U.S. Cl. CPC A23L 27/33; A23L 27/10; A23L 27/88; A23L 29/03

(57) ABSTRACT

The present disclosure is directed to sweetener composition comprising 1,3-propanediol and a sweetener. As disclosed are food, beverage, confection, or concentrate compositions comprising the aforementioned sweetener composition and methods of producing such sweeteners.

### CROSS-REFERENCE TO RELATED APPLICATIONS

This application claims priority to U.S. Provisional Application No. 63/407,250, filed on Sep. 16, 2022, the content of which is incorporated herein by reference in its entirety.

### FIELD

The present disclosure relates to the area of beverage, food, confection, and concentrate (caloric, bulk, and high potency) sweeteners and provides enhanced sweetness and/or reduced bitterness of sweeteners.

### BACKGROUND

Natural sugars, such as sucrose, fructose, and glucose, are utilized in the food and beverage industries to provide a pleasant taste to beverages, foods, confections, and concentrates. In addition, natural sugars are commonly used in pharmaceuticals, nutraceuticals, and oral hygienic/cosmetic products to similarly impart a pleasant taste. Sucrose, in particular, imparts a taste that is highly preferred by many consumers. Although sucrose provides superior sweetness characteristics, it is caloric. High-potency sweeteners have been introduced to address consumer demand for products having a pleasant taste, while at the same time meet increasing demand for healthier, reduced calorie products. Moreover, the demand for healthier, reduced calorie products is being driven by public policy and regulatory mandates.

However, high-potency sweeteners differ significantly from natural caloric sugars in ways that frustrate consumers and limit market penetration of products containing many high-potency sweeteners. On a taste basis, high-potency sweeteners exhibit temporal profiles, maximal responses, flavor profiles, mouthfeels, and adaptation behaviors that differ from sugar. Commonly, high-potency sweeteners exhibit delayed sweetness onsets, lingering sweet aftertastes, bitter off tastes, astringent tastes, cooling and/or licorice-like tastes. High-potency sweeteners may be synthetic chemicals, natural substances, physically or chemically modified natural substances, and/or reaction products obtained from synthetic and/or natural substances. The desire for natural high-potency sweeteners with favorable taste characteristics remains high.

One class of high-potency sweeteners are the steviol glycosides. However, utilization has been limited to date by certain undesirable taste properties, including licorice and bitter off tastes, astringency, and lingering sweet aftertaste. These undesirable taste properties tend to become more prominent with increased concentration.

Published U.S. Patent Application No. 20210127724 discloses use of 1,3-propanediol, to improve the taste and/or off-taste of commercial energy drinks. Including 1,3-propanediol in aqueous solutions containing two or more of about 250 ppm to about 4,000 ppm of a bitter additive, about 3,000 ppm to about 15,000 ppm of a sour additive, and about 600 ppm to about 3,000 ppm of a sweetener improved taste and/or off-taste of those solutions.

U.S. Pat. Nos. 9,408,406, 9,883,691, 10,201,176, and 10,238,135 disclose food or beverages prepared with 1,3-propanediol having modified flavor profiles. Published U.S. Patent Application No. 2021/0127724 discloses methods of improving taste and/or off-taste of a food, beverage, confection, or concentrate composition comprising providing a food, beverage, confection, or concentrate composition comprising two or more of a sour additive, a bitter additive; and a sweetener; and adding 1,3-propanediol to the food, beverage, confection, or concentrate composition to form a tasteful composition.

Thus, there remains a need for compositions and methods that improve sweetness and/or bitterness of a sweetener.

### SUMMARY

One aspect is for a sweetener composition comprising: (a) about 600 ppm to about 1,000 ppm of 1,3-propanediol; and (b) about 90 ppm to about 400 ppm of a sweetener. In some embodiments, the sweetener is a Stevia sweetener, and in some embodiments, the Stevia sweetener is Stevia Reb A97 or Stevia Reb M95.

Another aspect is for a food, beverage, confection, or concentrate composition comprising the aforementioned sweetener composition.

A further aspect is for a sweetener composition comprising: about 1 ppm to about 10 ppm of 1,3-propanediol; and (b) about 18,000 ppm to about 62,000 ppm of a sweetener. In some embodiments, the sweetener is sucrose, high fructose corn syrup, erythritol, allulose, or tagatose.

An additional aspect is for a food, beverage, confection, or concentrate composition comprising the aforementioned sweetener composition.

Another aspect is for a method of improving sweetness and/or reducing bitterness of a sweetener comprising: (a) providing about 90 ppm to about 400 ppm of a sweetener; and (b) adding an amount of 1,3-propanediol from about 600 ppm to about 1,000 ppm to the sweetener to form a sweetener composition, whereby said sweetener composition has improved sweetness and/or bitterness as compared to sweetener that does not include said amount of 1,3-propanediol. In some embodiments, the sweetener is a Stevia sweetener, and in some embodiments, the Stevia sweetener is Stevia Reb A97 or Stevia Reb M95.

A further aspect is for a sweetener composition produced by the aforementioned method.

An additional aspect is for a food, beverage, confection, or concentrate composition comprising the aforementioned sweetener composition.

Another aspect is for a method of improving sweetness and/or reducing bitterness of a sweetener comprising: (a) providing about 18,000 ppm to about 62,000 ppm of a sweetener; and (b) adding an amount of 1,3-propanediol from about 1 ppm to about 10 ppm to the sweetener to form a sweetener composition, whereby said sweetener composition has improved sweetness and/or bitterness as compared to sweetener that does not include said amount of 1,3-propanediol. In some embodiments, the sweetener is sucrose, high fructose corn syrup, erythritol, allulose, or tagatose.

A further aspect is for a sweetener composition produced by the aforementioned method.

An additional aspect is for a food, beverage, confection, or concentrate composition comprising the aforementioned sweetener composition.

Other objects and advantages will become apparent to those skilled in the art upon reference to the detailed description that hereinafter follows.

### BRIEF DESCRIPTION OF THE DRAWINGS

FIG. 1 shows a chart of sweetness, flavor, and bitterness of plain Greek yogurt with and without Zemea® USP-FCC Propanediol.

FIG. 2 shows a chart of sweetness, flavor, and bitterness of vanilla yogurt with and without Zemea® USP-FCC Propanediol.

FIG. 3 shows a chart of sweetness, flavor, and bitterness of orange juice (no pulp) with and without Zemea® USP-FCC Propanediol.

FIG. 4 shows a chart of sweetness, flavor, and bitterness of cranberry juice with and without Zemea® USP-FCC Propanediol.

FIG. 5 shows a chart of sweetness, flavor, and bitterness of grapefruit juice with and without Zemea® USP-FCC Propanediol.

### DETAILED DESCRIPTION

The inventors have discovered that 1,3-propanediol, in some embodiments biologically-produced 1,3-propanediol, may improve sweetness and/or reduce bitterness in sweeteners.

“Sweetener”, as used herein, refers to a substance that provides detectable sweetness when present in a food, beverage, confection, or concentrate. Accordingly, “sweetening amount”, as used herein, refers to the amount of compound required to provide detectable sweetness when present in a food, beverage, confection, or concentrate. A sweetener can be natural, synthetic, or a combination thereof. A sweetener can be a salt of a compound, an acid of a compound, or have no salt and/or acid presence.

The term “bitter” or “bitter taste” as used herein refers to the perception or gustatory sensation resulting following the detection of a bitter component. The following flavor attributes may contribute to bitter taste: astringent, bitter-astringent, metallic, bitter-metallic, as well as off-tastes aftertastes and undesirable tastes including, but not limited to, freezer-burn and card-board taste or a combination of these.

A “concentrate”, as used herein, means a liquid or powdered composition that can be diluted with an aqueous, potable liquid or a dry bulk powder to prepare a finished product. It also refers to a beverage or food precursor or “syrup” or “beverage syrup” to which a fluid, typically water or other diluting agent, is removed. It is then re-added to form a ready-to-drink high concentration beverage, or a “beverage”, or an “energy shot”, and ready-to-eat high concentration food, or a “food”, or a “condiment”. Typically, it can be up to about 2, about 3, about 4, about 5, about 6, about 7, about 8, about 9, or about 10 fold or more or about 2, about 3, about 4, about 5, about 6, about 7, about 8, about 9, or about 10 times or more larger quantity of a substance(s) present in a unit amount of mixture, meaning a significant amount of solute dissolved in a given solvent or solution. An exemplary concentrate is “frozen concentrate” orange juice. Its undiluted concentrate has much stronger flavor and sourness, and is sweeter than the normal, diluted juice.

The term “natural flavor” or “natural flavoring” means the essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or similar plant material, meat, seafood, poultry, eggs, dairy products, or fermentation products thereof, whose significant function in food is flavoring rather than nutritional.

As used herein, the term “about” or “approximately” means within 20%, 19%, 18%, 17%, 16%, 15%, 14%, 13%, 12%, 11%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, or 0.1%, or less or more of a given value or range.

The term “comprising” is intended to include embodiments encompassed by the terms “consisting essentially of” and “consisting of”. Similarly, the term “consisting essentially of” is intended to include embodiments encompassed by the term “consisting of”.

Because the food, beverage, confection, or concentrate composition provided according to the methods of the disclosure are not limited, it should be appreciated that the step of adding 1,3-propanediol, in some embodiments biologically-produced 1,3-propanediol, to the food, beverage, confection, or concentrate composition may be accomplished by any suitable method for each specific food, beverage, confection, or concentrate composition. For example, 1,3-propanediol, in some embodiments biologically-produced 1,3-propanediol, may be added directly to beverages and mixed, e.g., by stirring. In one embodiment, 1,3-propanediol, in some embodiments biologically-produced 1,3-propanediol, may be added as an aqueous solution or in a mixture with another additive, e.g., high fructose corn syrup, simple syrup, agave nectar, or aqueous solutions of sweeteners such as sucralose, sucrose, glucose, sugar, acesulfame potassium, aspartame, erythritol, high fructose corn syrup, or a combination thereof. These methods of addition would be suitable to prepare beverages, such as fruit juices, juice punches, concentrates, dilutions, “ades”, and sodas, for example.

For the first time, the inventors have shown that 1,3-propanediol, in some embodiments biologically-produced 1,3-propanediol, improves the sweetness and/or reduces bitterness of sweeteners. Surprisingly, including about 600 ppm to about 1,000 ppm 1,3-propanediol, in some embodiments biologically-produced 1,3-propanediol, with about 90 ppm to about 400 ppm of a sweetener, or including about 1 ppm to about 10 ppm 1,3-propanediol, in some embodiments biologically-produced 1,3-propanediol, with about 18,000 ppm to about 62,000 ppm of a sweetener improved the sweetness and/or reduced the bitterness of the sweetener.

Further aspects of the compositions and methods disclosed herein are provided in the following description.

In addition to improving sweetness and/or reducing bitterness of a sweetener, 1,3-propanediol, in some embodiments biologically-produced 1,3-propanediol, may modulate a taste impression of a food, beverage, confection, or concentrate composition. As used herein, the term “modulating a taste impression” means changing at least one aspect of a sensory description obtained using the methods described in the examples as compared to a composition that does not include any 1,3-propanediol. In another aspect, 1,3-propanediol, in some embodiments biologically-produced 1,3-propanediol, may mask or reduce one or more tastes reported in a sensory description as compared to the sensory description of a food, beverage, confection, or concentrate composition that does not include any 1,3-propanediol.

In one embodiment, a sweetener composition disclosed herein may be added to juices. For example, the sweetener composition can decrease the bitterness and increase the sweetness of grapefruit juice, orange juice, or cranberry juice. Other suitable beverage compositions include coffee, cocoa, tea (e.g., black tea, green tea, oolong tea etc.), or kombucha.

In one embodiment, a sweetener composition disclosed herein may be added to milk, which optionally is further mixed with coffee, espresso, or tea. In another embodiment, the milk is used to make cheese, yogurt, kefir, butter, puddings, custards, ice cream, or other dairy products. In the case of yogurts, a sweetener composition disclosed herein may be mixed with the yogurt after it is cultured rather than mixing it with the milk before the culturing step.

In one embodiment, a sweetener composition disclosed herein is added to fruit by soaking fruit in an aqueous liquid or syrup that contains the sweetener composition. Fruits may be whole (e.g., berries), pitted (e.g., cherries, peaches, nectarines, plums), peeled (e.g., citrus fruits), and/or sliced. In one embodiment, a sweetener composition disclosed herein is added to a brine used to pickle a fruit, vegetable, or meats. In one embodiments, fruits or vegetables are cleaned, and a sweetener composition disclosed herein is added to the fruits or vegetables by spraying a water or ethanol-based solution containing the sweetener on the fruits, vegetables, or mixtures thereof (e.g., fruit or vegetable salads). In one embodiment, a sweetener composition disclosed herein is added to jams or jellies, e.g., orange marmalade, before or after cooking.

In one embodiment, a sweetener composition disclosed herein may be added to dessert or savory sauces to make tasteful compositions. For example, dessert sauces such as chocolate, caramel, butterscotch, strawberry, cherry, pineapple, or other fruit flavors may include the sweetener composition. Savory sauces suitable for mixing with a sweetener composition disclosed herein include barbecue sauce, teriyaki sauce, oyster sauce, spice sauce, and other sauces that have high concentrations of sweet, salty, umami, and/or sour additives.

In one embodiment, a sweetener composition disclosed herein is added to confections, such as chocolate, chewing gum, sour soft candies, and sour hard candies.

In some embodiments, the food, beverage, confection, or concentrate product comprises a sweetener composition disclosed herein and a sour additive. In some embodiments, the food, beverage, confection, or concentrate product comprises a sweetener composition disclosed herein and a bitter additive. In some embodiments, the food, beverage, confection, or concentrate product comprises a sweetener composition disclosed herein, a sour additive. and a bitter additive.

### 1 1,3-Propanediol

“1,3-propanediol” or “PDO” refers to biologically-produced 1,3-propanediol. The terms “biologically-produced 1,3-propanediol”, “bioPDO”, “biologically-produced, biodegradable 1,3-propanediol”, “renewably-based 1,3-propanediol”, “renewably-based, biodegradable 1,3-propanediol,” “biosourced,” and “biologically-produced 1,3-propanediol” and similar terms as used herein refer to 1,3-propanediol derived from microorganism metabolism of plant-derived sugars composed of carbon of atmospheric origin, and not composed of fossil-fuel carbon.

When selecting food, beverage, and confection products, consumers consider product safety, environmental impact, the extent to which the components are natural, and the aesthetic quality of the overall product. Biologically-produced 1,3-propanediol (e.g., Zemea® Propanediol by Primient Covation LLC) is well suited to meet these consumer demands. High-purity 1,3-propanediol can be obtained from fermentation-based processes for incorporation into food, beverage, and confection compositions. It has less environmental impact than synthetically produced glycols, because biodegradation of biologically-produced 1,3-propanediol contributes no anthropogenic CO₂ emissions to the atmosphere.

1.1 Environmental Impact

Advantageously, biologically-produced 1,3-propanediol can be biodegradable and can have an anthropogenic CO₂ emission profile of zero (0). The term “biodegradable” means the capacity of a composition or compound to be broken down by living organisms to simple, stable compounds such as carbon dioxide and water in a relatively short time, e.g., less than years or months, as opposed to plastics. An “anthropogenic emission profile” means anthropogenic CO₂ emissions that are contributed to the atmosphere upon biodegradation of a compound or composition.

Whereas photosynthesis is the process of creating growing matter through the conversion of carbon dioxide (CO₂) and water (H₂O) into plant material through the action of the sun, biodegradation is the process of converting organic material back into CO₂ and H₂O through the activity of living organisms. There are many published test methods for measuring the biodegradability of organic chemicals such as glycols. One internationally recognized method is ASTM E1720-01, Standard Test Method for Determining Ready, Ultimate Biodegradability of Organic Chemicals in a Sealed Vessel CO₂ Production Test. Chemicals that demonstrate 60% biodegradation or better in this test method will biodegrade in most aerobic environments and are classified as ready biodegradable. All of the glycols referred to in this document meet this criterion.

Glycols such as ethylene glycol, propylene glycol, 1,3-butylene glycol, and 2-methyl-1,3-propanediol are biodegradable compounds useful in compositions ranging from cosmetics and personal care formulations to detergents to heat transfer compositions. While biodegradability is an important factor in protecting the environment, biodegradation of glycols derived from fossil-based sources has the unavoidable consequence of releasing previously fixed CO₂ into the atmosphere. Thus, while glycols in general are advantageous for their biodegradability, the resulting global warming potential of fossil-based glycols during biodegradation is significant.

Carbon dioxide is singled out as the largest component of the collection of greenhouse gases in the atmosphere. The level of atmospheric carbon dioxide has increased 50% in the last two hundred years. Recent reports indicate that the current level of atmospheric carbon dioxide is higher than the peak level in the late Pleistocene, the epoch before modern humans (Siegenthaler, U. et al. Stable Carbon Cycle-Climate Relationship During the Late Pleistocene, Science, Vol. 310, no. 5752 (Nov. 25, 2005), pp. 1313-1317). Therefore, any further addition of carbon dioxide to the atmosphere is thought to further shift the effect of greenhouse gases from stabilization of global temperatures to that of heating. Consumers and environmental protection groups alike have identified industrial release of carbon into the atmosphere as the source of carbon causing the greenhouse effect.

Greenhouse gas emission can occur at any point during the lifetime of a product. Consumers and environmental groups consider the full lifespan of a product when evaluating a product's environmental impact. Consumers look for products that do not contribute new carbon to the atmosphere considering the environmental impact of production, use and degradation. Only organic products composed of carbon molecules from plant sugars and starches and ultimately atmospheric carbon are considered to not further contribute to the greenhouse effect.

In addition to adding carbon dioxide to the atmosphere, current methods of industrial production of glycols produce contaminants and waste products that include among them sulfuric acid, hydrochloric acid, hydrofluoric acid, phosphoric acid, oxalic acid tartaric acid, acetic acids, Alkali metals, alkaline earth metals, transitional metals and heavy metals, including iron, cobalt, nickel, copper, silver, molybdenum, tungsten, vanadium, chromium, rhodium, palladium, osmium, iridium, rubidium, and platinum (U.S. Pat. Nos. 2,434,110, 5,034,134, 5,334,778, and 5,10,036).

1.1.1 Fossil Fuel Derived Carbon Feedstock Release

Calculations setting forth the finding that the 1,3-propanediol disclosed herein provides no anthropogenic CO₂ emissions upon biodegradation is set forth below. When one molecule of 1,3-propanediol degrades, three molecules of CO₂ are released into the atmosphere. Because all of these molecules of CO₂ released during degradation from “fermentatively-derived” 1,3-propanediol have an atmospheric origin, the net release of CO₂ to the atmosphere is thus zero. Comparatively, because a fossil fuel-derived propylene glycol and fossil-derived 1,3-propanediol contains three carbon atoms which originate from a fixed carbon source (i.e., the fossil fuel), degradation of one molecule of fossil fuel-derived propylene glycol or 1,3-propanediol results in a net release of three molecules of CO₂ into the atmosphere. Similarly, because fossil fuel-derived ethylene glycol contains two carbon atoms, which originate from a fixed carbon source, degradation of one molecule of fossil fuel-derived ethylene glycol results in a net release of two molecules of CO₂ into the atmosphere.

In order to quantify the CO₂ released for one kilogram of each ethylene glycol, propylene glycol, chemical 1,3-propanediol and “fermentatively-derived” 1,3 propanediol (Bio-PDO™), the product weight (1 kg) is divided by its molecular weight. For each carbon atom present in the molecule, one molecule of CO₂ is released. The molecules of CO₂ are multiplied by the molecular weight of CO₂ (44 kg/kmole) to quantify the impact of CO₂ release (kg) per one unit (kg) of product.

Fossil Fuel Derived Ethylene Glycol (EG)

$$1 kg EG ( \frac{1 k mol EG}{62.068 kg EG} ) ( \frac{2 k mol {CO}_{2}}{1 k mol EG} ) ( \frac{44 kg {CO}_{2}}{1 k mol {CO}_{2}} ) = 1.4 kg {CO}_{2}$$

Fossil Fuel Derived Propylene Glycol (PG)

$$1 kg PG ( \frac{1 k mol PG}{76.094 kg PG} ) ( \frac{3 k mol {CO}_{2}}{1 k mol PG} ) ( \frac{44 kg {CO}_{2}}{1 k mol {CO}_{2}} ) = 1.7 kg {CO}_{2}$$

Fossil Fuel Derived 1,3-Propanediol (PDO)

$$1 kg PDO ( \frac{1 k mol PDO}{76.094 kg PDO} ) ( \frac{3 k mol {CO}_{2}}{1 k mol PDO} ) ( \frac{44 kg {CO}_{2}}{1 k mol {CO}_{2}} ) = 1.7 kg {CO}_{2}$$

Biologically produced 1,3-Propanediol (Bio-PDO™) Carbon Feedstock Balance

Capture:

$$1 kg Bio - PDO ™ ( \frac{1 k mol Bio - PDO ™}{76.094 kg Bio - PDO ™} ) ( \frac{- 3 k mol {CO}_{2}}{1 k mol Bio - PDO ™} ) ( \frac{44 kg {CO}_{2}}{1 k mol {CO}_{2}} ) = - 1.7 kg {CO}_{2}$$

Release:

$$1 kg Bio - PDO ™ ( \frac{1 k mol Bio - PDO ™}{76.094 kg Bio - PDO ™} ) ( \frac{3 k mol {CO}_{2}}{1 k mol Bio - PDO ™} ) ( \frac{44 kg {CO}_{2}}{1 k mol {CO}_{2}} ) = 1.7 kg {CO}_{2}$$

Net:

−1.7kg CO₂+1.7kg CO₂=0kg CO₂

This Biologically-produced 1,3-Propanediol Carbon Feedstock Balance result demonstrates that there are no anthropogenic CO₂ emissions from the biodegradation of the renewably sourced biologically-produced 1,3-propanediol.

The term “anthropogenic” means man-made or fossil-derived.

“Carbon of atmospheric origin” as used herein refers to carbon atoms from carbon dioxide molecules that have recently, in the last few decades, been free in the earth's atmosphere. Such carbons in mass are identifiable by the presence of particular radioisotopes as described herein. “Green carbon”, “atmospheric carbon”, “environmentally friendly carbon”, “life-cycle carbon”, “non-fossil fuel based carbon”, “non-petroleum based carbon”, “carbon of atmospheric origin”, and “biobased carbon” are used synonymously herein.

“Carbon of fossil origin” as used herein refers to carbon of petrochemical origin. Such carbon has not been exposed to UV rays as atmospheric carbon has, therefore masses of carbon of fossil origin has few radioisotopes in their population. Carbon of fossil origin is identifiable by means described herein. “Fossil fuel carbon”, “fossil carbon”, “polluting carbon”, “petrochemical carbon”, “petro-carbon” and carbon of fossil origin are used synonymously herein.

The abbreviation “IRMS” refers to measurements of CO₂ by high precision stable isotope ratio mass spectrometry.

The term “carbon substrate” means any carbon source capable of being metabolized by a microorganism wherein the substrate contains at least one carbon atom.

“Renewably-based” denotes that the carbon content of the 1,3-propanediol is from a “new carbon” source as measured by ASTM test method D 6866-05 Determining the Biobased Content of Natural Range Materials Using Radiocarbon and Isotope Ratio Mass Spectrometry Analysis, incorporated herein by reference. This test method measures the C-14/C-12 isotope ratio in a sample and compares it to the C-14/C-12 isotope ratio in a standard 100% biobased material to give percent biobased content of the sample. “Biobased materials” are organic materials in which the carbon comes from recently (on a human time scale) fixated CO₂ present in the atmosphere using sunlight energy (photosynthesis). On land, this CO₂ is captured or fixated by plant life (e.g., agricultural crops or forestry materials). In the oceans, the CO₂ is captured or fixated by photosynthesizing bacteria or phytoplankton. A biobased material has a C-14/C-12 isotope ratio in range of from 1:0 to greater than 0:1. Contrarily, a fossil-based material, has a C-14/C-12 isotope ratio of 0:1.

A small amount of the carbon dioxide in the atmosphere is radioactive. This 14C carbon dioxide is created when nitrogen is struck by an ultra-violet light produced neutron, causing the nitrogen to lose a proton and form carbon of molecular weight 14 which is immediately oxidized in carbon dioxide. This radioactive isotope represents a small but measurable fraction of atmospheric carbon. Atmospheric carbon dioxide is cycled by green plants to make organic molecules during the process known as photosynthesis. The cycle is completed when the green plants or other forms of life metabolize the organic molecules producing carbon dioxide which is released back to the atmosphere. Virtually all forms of life on Earth depend on this green plant production of organic molecule to produce the chemical energy that facilitates growth and reproduction. Therefore, the 14C that exists in the atmosphere becomes part of all life forms, and their biological products. These renewably based organic molecules that biodegrade to CO₂ do not contribute to global warming as there is no net increase of carbon emitted to the atmosphere. In contrast, fossil fuel based carbon does not have the signature radiocarbon ratio of atmospheric carbon dioxide.

Atmospheric origin and fixed carbon source as used herein are relative terms in that the time period of when CO₂ is of atmospheric or fixed origin relates to the life cycle of the 1,3-propanediol. Thus, while it is quite possible that, at one time, carbon from a fossil fuel was found in the atmosphere (and, as a corollary, that atmospheric CO₂ may one day be incorporated into a fixed carbon source), for purposes herein carbon is considered to be from a fixed carbon source until it is released into the atmosphere by degradation.

Assessment of the renewably based carbon in a material can be performed through standard test methods. Using radiocarbon and isotope ratio mass spectrometry analysis, the biobased content of materials can be determined. ASTM International, formally known as the American Society for Testing and Materials, has established a standard method for assessing the biobased content of materials. The ASTM method is designated ASTM-D6866.

The application of ASTM-D6866 to derive a “biobased content” is built on the same concepts as radiocarbon dating, but without use of the age equations. The analysis is performed by deriving a ratio of the amount of radiocarbon (14C) in an unknown sample to that of a modem reference standard. The ratio is reported as a percentage with the units “pMC” (percent modern carbon). If the material being analyzed is a mixture of present day radiocarbon and fossil carbon (containing no radiocarbon), then the pMC value obtained correlates directly to the amount of biomass material present in the sample.

The modern reference standard used in radiocarbon dating is a NIST (National Institute of Standards and Technology) standard with a known radiocarbon content equivalent approximately to the year AD 1950. AD 1950 was chosen since it represented a time prior to thermo-nuclear weapons testing which introduced large amounts of excess radiocarbon into the atmosphere with each explosion (termed “bomb carbon”). The AD 1950 reference represents 100 pMC.

“Bomb carbon” in the atmosphere reached almost twice normal levels in 1963 at the peak of testing and prior to the treaty halting the testing. Its distribution within the atmosphere has been approximated since its appearance, showing values that are greater than 100 pMC for plants and animals living since AD 1950. It's gradually decreased over time with today's value being near 107.5 pMC. This means that a fresh biomass material such as corn could give a radiocarbon signature near 107.5 pMC.

Combining fossil carbon with present day carbon into a material will result in a dilution of the present day pMC content. By presuming 107.5 pMC represents present day biomass materials and 0 pMC represents petroleum derivatives, the measured pMC value for that material will reflect the proportions of the two component types. A material derived 100% from present day soybeans would give a radiocarbon signature near 107.5 pMC. If that material was diluted with 50% petroleum derivatives, it would give a radiocarbon signature near 54 pMC.

A biomass content result is derived by assigning 100% equal to 107.5 pMC and 0% equal to 0 pMC. In this regard, a sample measuring 99 pMC will give an equivalent biobased content result of 93%.

A sample of “fermentatively-derived” 1,3-propanediol was submitted by DuPont to Iowa State University for biobased content analysis using ASTM method D 6866-05. The results received from Iowa State University demonstrated that the above sample was 100% bio-based content (ref: Norton, Glenn. Results of Radiocarbon Analyses on samples from DuPont Bio-Based Materials—reported 07-08-05).

Assessment of the materials described herein were done in accordance with ASTM-D6866. The mean values quoted in this report encompass an absolute range of 6% (plus and minus 3% on either side of the biobased content value) to account for variations in end-component radiocarbon signatures. It is presumed that all materials are present day or fossil in origin and that the desired result is the amount of biobased component “present” in the material, not the amount of biobased material “used” in the manufacturing process.

1.2 1,3-Propanediol Content

In one embodiment, the sweetener composition of the disclosure may contain about 0.1 ppm, about 0.2 ppm, about 0.3 ppm, about 0.4 ppm, about 0.5 ppm, about 0.6 ppm, about 0.7 ppm, about 0.8 ppm, about 0.9 ppm, about 1 ppm, about 1.5 ppm, about 2 ppm, about 2.5 ppm, about 3 ppm, about 3.5 ppm, about 4 ppm, about 4.5 ppm, about 5 ppm, about 5.5 ppm, about 6 ppm, about 6.5 ppm, about 7 ppm, about 7.5 ppm, about 8 ppm, about 8.5 ppm, about 9 ppm, about 9.5 ppm, about 10 ppm, about 11 ppm, about 12 ppm, about 13 ppm, about 14 ppm, or about 15 ppm 1,3-propanediol, in some embodiments biologically-produced 1,3-propanediol. These values can also be expressed as ranges. For example, about 0.1 ppm to about 15 ppm, about 0.2 ppm to about 14 ppm, about 0.3 ppm to about 13 ppm, about 0.4 ppm to about 11 ppm, about 0.5 ppm to about 10 ppm, about 0.6 ppm to about 10 ppm, about 0.7 ppm to about 10 ppm, about 0.8 ppm to about 10 ppm, about 0.9 ppm to about 10 ppm, or about 1 ppm to about 10 ppm 1,3-propanediol, in some embodiments biologically-produced 1,3-propanediol, may be included in the sweetener composition of the disclosure.

In one embodiment, the sweetener composition of the disclosure may contain about 500 ppm, about 510 ppm, about 520 ppm, about 530 ppm, about 540 ppm, about 550 ppm, about 560 ppm, about 570 ppm, about 580 ppm, about 590 ppm, about 600 ppm, about 610 ppm, about 620 ppm, about 630 ppm, about 640 ppm, about 650 ppm, about 660 ppm, about 670 ppm, about 680 ppm, about 690 ppm, about 700 ppm, about 710 ppm, about 720 ppm, about 730 ppm, about 740 ppm, about 750 ppm, about 760 ppm, about 770 ppm, about 780 ppm, about 790 ppm, about 800 ppm, about 810 ppm, about 820 ppm, about 830 ppm, about 840 ppm, about 850 ppm, about 860 ppm, about 870 ppm, about 880 ppm, about 890 ppm, about 900 ppm, about 910 ppm, about 920 ppm, about 930 ppm, about 940 ppm, about 950 ppm, about 960 ppm, about 970 ppm, about 980 ppm, about 990 ppm, about 1,000 ppm, about 1,010 ppm, about 1,020 ppm, about 1,030 ppm, about 1,040 ppm, about 1,050 ppm, about 1,060 ppm, about 1,070 ppm, about 1,080 ppm, about 1,090 ppm, about 1,100 ppm, about 1,110 ppm, about 1,120 ppm, about 1,130 ppm, about 1,140 ppm, about 1,150 ppm, about 1,160 ppm, about 1,170 ppm, about 1,180 ppm, about 1,190 ppm, or about 1,200 ppm 1,3-propanediol, in some embodiments biologically-produced 1,3-propanediol. These values can also be expressed as ranges. For example, about 500 ppm to about 1,200 ppm, about 550 ppm to about 1,100 ppm, about 600 ppm to about 1,000 ppm, about 650 ppm to about 900 ppm, or about 700 ppm to about 850 ppm 1,3-propanediol, in some embodiments biologically-produced 1,3-propanediol, may be included in the sweetener composition of the disclosure.

Food, beverage, confection, or concentrate compositions of the present disclosure may include 1,3-propanediol, in some embodiments biologically-produced 1,3-propanediol, as part of the, or as the sole, glycol component of the composition. It is contemplated that other renewably-based or biologically-produced glycols, such as ethylene glycol, dietheylene glycol, triethylene glycol, 1,2 propylene glycol, dipropylene glycol, tripropylene glycol, neopentyl glycol and bisphenol A, among others, can be used in the food, beverage, and confection compositions of the disclosure.

1.3 Purity

Consumers seek products that are composed of additives of a more purified source and/or of all natural composition. Also of concern to consumers, especially consumers of food products, is among other things, an individual's reaction to such a product. The rate of development of hypersensitivity has markedly increased in the US in the last two decades. Many of these reactions are attributed to trace amount of substances. Other reactions are of idiopathic origin.

In one embodiment, the biologically-produced 1,3-propanediol of the present disclosure can be substantially purified. “Substantially purified,” as used herein, denotes a composition comprising 1,3-propanediol having one or more of the following characteristics: (1) an ultraviolet absorption at 220 nm of less than about 0.200 and at 250 nm of less than about 0.075 and at 275 nm of less than about 0.075 absorbance units using a one centimeter path length and dilution of the 1,3-propanediol in a 1 to 5 dilution with glass-distilled water; (2) a composition having L*a*b* “b*” color value of less than about 0.15 and an absorbance at 270 nm of less than about 0.075 absorbance units using a one centimeter path length and dilution of the 1,3-propanediol in a 1 to 5 dilution with glass-distilled water; (3) a peroxide composition of less than about 200, 150, 100, 50, 40, 30, 20, 10, 5, 1 or about 0.5 ppm; and (4) a concentration of total organic impurities of less than about 1,000, 900, 800, 700, 600, 500, 400, 300, 200, 150, 100, 50 or about 10 ppm. Any of these sets of values can be used to define a range, such as a peroxide composition of about 0.5 ppm to about 200 ppm, about 1 ppm to about 150 ppm, about 5 ppm to about 100 ppm, about 10 ppm to about 50 ppm, or about 20 ppm to about 40 ppm. The concentration of total organic impurities may range from about 10 ppm to about 1,000 ppm, about 50 ppm to about 900 ppm, about 100 ppm to about 800 ppm, about 150 ppm to about 700 ppm, about 200 ppm to about 600 ppm, or about 300 ppm to about 500 ppm.

A “b*” value is the spectrophotometrically determined “Yellow Blue” measurement as defined by the CIE L*a*b* measurement ASTM D6290.

By the terms “color” and “color bodies” is meant the existence of visible color that can be quantified using a spectrocolorimeter in the range of visible light, using wavelengths of approximately 400-800 nm, and by comparison with pure water. Reaction conditions can have an important effect on the nature of color production. Examples of relevant conditions include the temperatures used, the catalyst and amount of catalyst. While not wishing to be bound by theory, color precursors are believed to include trace amounts of impurities comprising olefinic bonds, acetals and other carbonyl compounds, peroxides, etc. At least some of these impurities may be detected by such methods as UV spectroscopy, or peroxide titration.

The peroxide composition in ppm and total organic impurities can be determined by standard analytical techniques, including gas chromatography.

It is believed that the aforementioned purity level parameters for biologically-produced and purified 1,3-propanediol distinguishes such compositions from 1,3-propanediol compositions prepared from chemically purified 1,3-propanediol derived from petroleum sources and/or from biologically purified 1,3-propanediol not exhibiting such purity values.

The abbreviation “AMS” refers to accelerator mass spectrometry.

By the acronym “NMR” is meant nuclear magnetic resonance.

“Color index” refers to an analytic measure of the electromagnetic radiation-absorbing properties of a substance or compound.

It is believed that the aforementioned purity level parameters for biologically-produced and purified 1,3-propanediol (using methods similar or comparable to those disclosed in U.S. Patent Application No. 2005/0069997) distinguishes such compositions from 1,3-propanediol compositions prepared from chemically purified 1,3-propanediol derived from petroleum sources, as per the prior art.

In some embodiments, extracts of a glycol or glycols (in some embodiments, 1,3-propanediol) may be used in any purity percentage (e.g., about 25% to 100%, and any increment range described therein in increments of 0.5%). In another embodiment, when a glycol is used as a non-extract, the purity of the glycol can be about 25% to 100%, and any increment range described therein in increments of 0.5%. According to other embodiments, the purity of the glycol (extract or non-extract) can be about 50% to 100%, about 70% to 100%, about 80% to 100%, about 90% to 100%; about 95% to 100%, about 95% to 99.5%, about 96% to 100%, about 97% to 100%, about 98% to 100%, or about 99% to 100%. According to particular embodiments, the purity of a 1,3-propanediol can be about 50% to 100%, about 70% to 100%, about 80% to 100%, about 90% to 100%, about 95% to 100%, about 95% to 99.5%, about 96% to 100%, about 97% to 100%, about 98% to 100%, or about 99% to 100%.

1.4 Biologically-Produced 1,3-Propanediol Production

“Biologically-produced” means organic compounds produced by one or more species or strains of living organisms, including particularly strains of bacteria, yeast, fungus and other microbes. “Bio-produced” and Biologically-produced are used synonymously herein. Such organic compounds are composed of carbon from atmospheric carbon dioxide converted to sugars and starches by green plants.

“Biologically-derived” means that the organic compound is synthesized from biologically produced organic components. It is further contemplated that the synthesis process disclosed herein is capable of effectively synthesizing other monoesters and diesters from bio-produced alcohols other than 1,3-propanediol; particularly including ethylene glycol, diethylene glycol, triethylene glycol, 1,2-propylene glycol, dipropylene diol, tripropylene diol, 2-methyl 1,3-propanediol, neopentyl glycol and bisphenol A. “Biologically-derived”, and “bio-derived,” “biologically-based,” “bio-based”, and “bio-sourced” are used synonymously herein.

In one embodiment, biologically-produced 1,3-propanediol can be obtained based upon use of the fermentation broth (“fermentatively-derived”) generated by a genetically-engineered Escherichia coli (E. coli) previously disclosed in, for example, U.S. Pat. No. 5,686,276. In other embodiments, one or more single organisms, or combinations of organisms, may be used to biologically produce 1,3-propanediol, using organisms that have been genetically-engineered according to methods known in the art. “Fermentation” refers to a system that catalyzes a reaction between substrate(s) and other nutrients to product(s) through use of a biocatalyst. The biocatalysts can be a whole organism, an isolated enzyme, or any combination or component thereof that is enzymatically active. Fermentation systems useful for producing and purifying biologically-produced 1,3-propanediol are disclosed in, for example, U.S. Pat. No. 7,919,658 incorporated herein by reference.

### 2 Bitter Compounds

In some embodiments, the bitter additive is a branched amino acid such as L-leucine, L-valine, or L-isoleucine; caffeine; quinine HCl and its various salts; hesperidin; sucrose octaacetate; quercetin; brucine; quassin; isohumulones; stevia extracts; saccharin; naringin; gustducin; catechin; sesquiterpene lactone; aristolochic acid; phenylthiocarbamide; propylthiouracil; flavones; noscapine; humulone; amarogentin; glucoside; limonin; amarogentin; goitrin; cynaropicrin; quassin; cycloheximide; dipeptides; any other bitter-tasting compounds from vegetables, fruits (for example, naringin and guarana), cocoa (for example, chocolate), cereals, or spices; or a combination thereof.

In some embodiments, compositions include a bitter additive at about 250 ppm, about 275 ppm, about 300 ppm, about 325 ppm, about 350 ppm, about 375 ppm, about 400 ppm, about 425 ppm, about 450 ppm, about 475 ppm, about 500 ppm, about 525 ppm, about 550 ppm, about 575 ppm, about 600 ppm, about 625 ppm, about 650 ppm, about 675 ppm, about 700 ppm, about 725 ppm, about 750 ppm, about 775 ppm, about 800 ppm, about 825 ppm, about 850 ppm, about 875 ppm, about 900 ppm, about 925 ppm, about 950 ppm, about 975 ppm, about 1,000 ppm, about 1,250 ppm, about 1,500 ppm, about 1,750 ppm, about 2,000 ppm, about 2,250 ppm, about 2,500 ppm, about 2,750 ppm, about 3,000 ppm, about 3,250 ppm, about 3,500 ppm, about 3, 750 ppm, or about 4,000 ppm. These bitter additive content values can also be expressed as ranges, for example: about 250 ppm to about 4,000 ppm, about 275 ppm to about 3, 750 ppm, about 300 ppm to about 3,500 ppm, about 325 ppm to about 3,250 ppm, about 350 ppm to about 3,000 ppm, about 375 ppm to about 2,750 ppm, about 400 ppm to about 2,500 ppm, about 425 ppm to about 2,250 ppm, about 450 ppm to about 2,000 ppm, about 475 ppm to about 1,750 ppm, about 500 ppm to about 1,500 ppm, about 525 ppm to about 1,250 ppm, about 550 ppm to about 1,000 ppm, about 575 ppm to about 975 ppm, about 600 ppm to about 950 ppm, about 625 ppm to about 925 ppm, about 650 ppm to about 900 ppm, about 675 ppm to about 875 ppm, about 700 ppm to about 850 ppm, about 725 ppm to about 825 ppm, or about 750 ppm to about 800 ppm.

### 3 Sweeteners

In some embodiments, the sweetener can be providing in pure or less pure form or as part of a mixture, i.e. a sweetener blend or a carbohydrate blend or a carbohydrate/high-potency sweetener blend or high-potency sweetener blend or a steviol glycoside blend or a mogroside blend. Exemplary carbohydrade sweeteners include, but are not limited to, cane sucrose, beet sucrose, sucrose, high fructose corn/starch syrup, glucose syrup, glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheptulose, octolose, fucose, rhamnose, arabinose, turanose, sialose, sorbose, lyxose, ribulose, xylose, xylulose, D-allose, L-ribose, D-tagatose, L-glucose, L-fucose, L-arabinose, turanose, erythritol, hydrogenated starch hydrolysates (HSH), isomalt, lactitol, maltitol, mannitol, sorbitol, allulose, xylitol, and combinations thereof.

Exemplary high-potency sweeteners include, but are not limited to, monatin, curculin, glycyrrhizic acid, thaumatin, modnellin, mabinlin, brazzein, hernandulcin, phyllodulcin, glycyphyllin, phloridzin, trilobatin, baiyunoside, osladin, polypodoside A, pterocaryoside, cyclocarioside I, sucralose, potassium acesulfame, acesulfame acid, aspartame, alitame, saccharin, neohesperidin dihydrochalcone, cyclamate, cyclamic acid, neotame, advantame, allulose, xylitol, rebaudioside A, rebaudioside B, rebaudioside C, rebaudioside D, rebaudioside D2, rebaudioside E, rebaudioside F, rebaudioside G, rebaudioside H, rebaudioside I, rebaudioside J, rebaudioside K, rebaudioside L, rebaudioside M, rebaudioside M2, rebaudioside N, rebaudioside 0, rebaudioside S, rebaudioside T, rebaudioside U, rebaudioside V, rebaudioside W, rebaudioside Z1, rebaudioside Z2, rebaudioside IX, dulcoside A, dulcoside B, rubusoside, steviolbioside, steviolmonoside, grosmogroside I, mogroside IA, mogroside IE, 11-oxo-mogroside IA, mogroside II, mogroside IIA, mogroside IIB, mogroside IIE, 7-oxo-mogroside IV, 11-oxo-mogroside IVA, mogroside V, isomogroside V, 11-deoxymogroside V, 7-oxo-mogroside V, 11-oxo-mogroside V, isomogroside V, mogroside VI, mogrol, 11-oxomogrol, siamenoside I, enzymatically glucosylated steviol glycosides, and combinations thereof.

In one embodiment, the composition includes one or more high-potency sweeteners depending on their sweet potencies except advantame, alitame, monatin, neotame, thaumatin and brazzein, with each sweetener in the composition at about 600 ppm, about 700 ppm, about 800 ppm, about 900 ppm, 1,000 ppm, about 1,100 ppm, about 1,200 ppm, about 1,300 ppm, about 1,400 ppm, about 1,500 ppm, about 1,600 ppm, about 1,700 ppm, about 1,800 ppm, about 1,900 ppm, about 2,000 ppm, about 2,100 ppm, about 2,200 ppm, about 2,300 ppm, about 2,400 ppm, about 2,500 ppm, about 2,600 ppm, about 2,700 ppm, about 2,800 ppm, about 2,900 ppm, or about 3,000 ppm. These sweetener content values can also be expressed as ranges, about 600 ppm to about 3,000 ppm, 700 ppm to about 2,900 ppm, about 800 ppm to about 2,800 ppm, about 900 ppm to about 2,700 ppm, about 1,000 ppm to about 2,600 ppm, about 1,100 ppm to about 2,500 ppm, about 1,200 ppm to about 2,400 ppm, about 1,300 ppm to about 2,300 ppm, about 1,400 ppm to about 2,200 ppm, about 1,500 ppm to about 2,100 ppm, about 1,600 ppm to about 2,000, or about 1,700 ppm to about 1,900 ppm.

In one embodiment, the composition includes one or more high-potency sweeteners of alitame, monatin, thaumatin and brazzein, depending on their sweet potencies with each sweetener in the composition at about 120 ppm, about 220 ppm, about 320 ppm, about 420 ppm, 520 ppm, about 620 ppm, about 720 ppm, about 820 ppm, about 920 ppm, about 1,020 ppm, about 1,120 ppm, about 1,220 ppm, about 1,320 ppm, about 1,420 ppm, about 1,520 ppm, about 1,620 ppm, about 1,720 ppm, about 1,820 ppm, about 1,920 ppm, about 2,020 ppm, about 2,120 ppm, about 2,220 ppm, about 2,320 ppm, or about 2,420 ppm. These sweetener content values can also be expressed as ranges, about 120 ppm to about 2,420 ppm, 220 ppm to about 2,320 ppm, about 320 ppm to about 2,220 ppm, about 420 ppm to about 2,120 ppm, about 520 ppm to about 2,020 ppm, about 620 ppm to about 1,920 ppm, about 720 ppm to about 1,820 ppm, about 820 ppm to about 1,720 ppm, about 920 ppm to about 1,620 ppm, or about 1,020 ppm to about 1,520 ppm.

In one embodiment, the composition includes one or more high-potency sweeteners of advantame and neotame, depending on their sweet potencies with each sweetener in the composition at about 13 ppm, about 23 ppm, about 33 ppm, about 43 ppm, 53 ppm, about 63 ppm, about 73 ppm, about 83 ppm, about 93 ppm, about 103 ppm, about 113 ppm, about 123 ppm, about 133 ppm, about 143 ppm, about 153 ppm, about 163 ppm, about 173 ppm, about 183 ppm, about 193 ppm, about 203 ppm, about 213 ppm, about 223 ppm, about 233 ppm, or about 243 ppm. These sweetener content values can also be expressed as ranges, about 13 ppm to about 243 ppm, 23 ppm to about 233 ppm, about 33 ppm to about 223 ppm, about 43 ppm to about 213 ppm, about 53 ppm to about 203 ppm, about 63 ppm to about 193 ppm, about 73 ppm to about 183 ppm, about 83 ppm to about 173 ppm, about 93 ppm to about 163 ppm, or about 103 ppm to about 153 ppm.

In one embodiment, the composition includes one or more carbohydrate sweeteners, depending on their sweet potencies, with each sweetener in the composition at about 15,000 ppm, about 15,500 ppm, about 16,000 ppm, about 16,500 ppm, about 17,000 ppm, about 16,500 ppm, about 18,000 ppm, about 18,500 ppm, about 19,000 ppm, about 19,500 ppm, about 20,000 ppm, about 21,000 ppm, about 22,000 ppm, about 23,000 ppm, about 24,000 ppm, about 25,000 ppm, about 26,000 ppm, about 27,000 ppm, about 28,000 ppm, about 29,000 ppm, about 30,000 ppm, about 31,000 ppm, about 32,000 ppm, about 32,000 ppm, about 33,000 ppm, about 34,000 ppm, about 35,000 ppm, about 36,000 ppm, about 37,000 ppm, about 38,000 ppm, about 39,000 ppm, about 40,000 ppm, about 41,000 ppm, about 42,000 ppm, about 43,000 ppm, about 44,000 ppm, about 45,000 ppm, about 46,000 ppm, about 47,000 ppm, about 48,000 ppm, about 49,000 ppm, about 50,000 ppm, about 51,000 ppm, about 52,000 ppm, about 53,000 ppm, about 54,000 ppm, about 55,000 ppm, about 56,000 ppm, about 57,000 ppm, about 58,000 ppm, about 59,000 ppm, about 60,000 ppm, about 61,000 ppm, about 62,000 ppm, about 63,000 ppm, about 64,000 ppm, about 65,000 ppm, about 66,000 ppm, about 67,000 ppm, about 68,000 ppm, about 69,000 ppm, or about 70,000 ppm. These sweetener content values can also be expressed as ranges, about 15,000 ppm to about 70,000 ppm, 15,500 ppm to about 68,000 ppm, about 16,500 ppm to about 66,000 ppm, about 17,000 ppm to about 65,000 ppm, about 17,500 ppm to about 64,500 ppm, about 18,000 ppm to about 62,000 ppm, about 19,000 ppm to about 60,000 ppm, about 25,000 ppm to about 55,000 ppm, about 30,000 ppm to about 45,000 ppm, or about 35,000 ppm to about 45,000 ppm.

### 4 Other Additives

4.1 Vitamins

In any of the embodiments disclosed above, the composition may further include a vitamin selected from the group consisting of Vitamin A (retinoids, carotene), Vitamin C (ascorbic acid), Vitamin D (calciferol; and D2, D3, D4 and D5), Vitamin E (α-tocopherol), Vitamin K (and K2 and K3), Vitamin B1 (thiamine), Vitamin B2 (riboflavin), Vitamin B3 (niacin), Vitamin B5 (pantothenic acid), Vitamin B7 (Biotin), Vitamin B6 (pyridoxine), Vitamin B9 (folic acid, folate, folacin), Vitamin B12 (cyanocobalamin), and a combination thereof. In some embodiments, the food, beverage, confection, or concentrate composition can include “vitamin-like” additives, such as choline, carnitine, myo-inositol, para-aminobenzoic acid, and lipoic acid. Contemplated compositions include one, two, three, four, five, or more vitamins. For example, the composition may include niacin, pyridoxine, folic acid, and cyanocobalamin. In another exemplary embodiment, the composition may include niacin, pyridoxine, and cyanocobalamin. In further embodiments, the composition may include niacin, pantothenic acid, pyridoxine, and cyanocobalamin. In some embodiments, the composition may include riboflavin, niacin, pyridoxine, and cyanocobalamin. In other embodiments, the composition may include riboflavin, pantothenic acid, pyridoxine, and cyanocobalamin. In further embodiments, the composition may include pyridoxine and cyanocobalamin. In yet further embodiments, the composition may include riboflavin, niacin, pantothenic acid, pyridoxine, and cyanocobalamin.

In any of the foregoing embodiments, the composition can include riboflavin at about 0.5 mg, about 1.0 mg, about 1.5 mg, about 2.0 mg, about 2.5 mg, about 3.0 mg, about 3.5 mg, about 4.0 mg, about 4.5 mg, about 5.0 mg, about 5.5 mg, about 6.0 mg, about 6.5 mg, about 7.0 mg, about 7.5 mg, about 8.0 mg, about 8.5 mg, about 9.0 mg, about 9.5 mg, about 10.0 mg, about 11 mg, about 12 mg, about 13 mg, about 14 mg, about 15 mg, about 16 mg, about 17 mg, about 18 mg, about 19 mg, about 20 mg, about 21 mg, about 22 mg, about 23 mg, about 24 mg, about 25 mg, about 26 mg, about 27 mg, about 28 mg, about 29 mg, about 30 mg, about 31 mg, about 32 mg, about 33 mg, about 34 mg, about 35 mg, about 36 mg, about 37 mg, about 38 mg, about 39 mg, about 40 mg, about 41 mg, about 42 mg, about 43 mg, about 44 mg, about 45 mg, about 46 mg, about 47 mg, about 48 mg, about 49 mg, about 50 mg, about 51 mg, about 52 mg, about 53 mg, about 54 mg, about 55 mg, about 56 mg, about 57 mg, about 58 mg, about 59 mg, about 60 mg, about 61 mg, about 62 mg, about 63 mg, about 64 mg, about 65 mg, about 66 mg, about 67 mg, about 68 mg, about 69 mg, about 70 mg, about 71 mg, about 72 mg, about 73 mg, about 74 mg, about 75 mg, about 76 mg, about 77 mg, about 78 mg, about 79 mg, about 80 mg, about 81 mg, about 82 mg, about 83 mg, about 84 mg, about 85 mg, about 86 mg, about 87 mg, about 88 mg, about 89 mg, about 90 mg, about 91 mg, about 92 mg, about 93 mg, about 94 mg, about 95 mg, about 96 mg, about 97, about 98 mg, about 99 mg, about 100 mg, about 110 mg, about 120 mg, about 130 mg, about 140 mg, about 150 mg, about 160 mg, about 170 mg, about 180 mg, about 190 mg, about 200 mg, about 210 mg, about 220 mg, about 230 mg, about 240 mg, about 250 mg, about 260 mg, about 270 mg, about 280 mg, about 290 mg, about 300 mg, about 310 mg, about 320 mg, about 330 mg, about 340 mg, about 350 mg, about 360 mg, about 370 mg, about 380 mg, about 390 mg, about 400 mg, about 410 mg, about 420 mg, about 430 mg, about 440 mg, about 450 mg, about 460 mg, about 470 mg, about 480 mg, about 490 mg, about 500 mg, about 510 mg, about 520 mg, about 530 mg, about 540 mg, about 550 mg, about 560 mg, about 570 mg, about 580 mg, about 590 mg, about 600 mg, about 610 mg, about 620 mg, about 630 mg, about 640 mg, about 650 mg, about 660 mg, about 670 mg, about 680 mg, about 690 mg, about 700 mg, about 710 mg, about 720 mg, about 730 mg, about 740 mg, about 750 mg, about 760 mg, about 770 mg, about 780 mg, about 790 mg, about 800 mg, about 810 mg, about 820 mg, about 830 mg, about 840 mg, about 850 mg, about 860 mg, about 870 mg, about 880 mg, about 890 mg, or about 900 mg.

Riboflavin content values can also be expressed as ranges, for example: about 0.5 mg to about 900 mg, about 1 mg to about 900 mg, about 2 mg to about 900 mg, about 5 mg to about 900 mg, about 10 mg to about 900 mg, about 25 mg to about 900 mg, about 50 mg to about 900 mg, about 100 mg to about 900 mg, about 150 mg to about 900 mg, about 200 mg to about 900 mg, about 300 mg to about 900 mg, about 400 mg to about 900 mg, about 500 mg to about 900 mg, about 600 mg to about 900 mg, about 700 mg to about 900 mg, about 800 mg to about 900 mg, about 0.5 mg to about 850 mg, about 0.5 mg to about 800 mg, about 0.5 mg to about 750 mg, about 0.5 mg to about 600 mg, about 0.5 mg to about 500 mg, about 0.5 mg to about 400 mg, about 0.5 mg to about 300 mg, about 0.5 mg to about 200 mg, about 0.5 mg to about 100 mg, about 0.5 mg to about 50 mg, about 0.5 mg to about 25 mg, about 0.5 mg to about 10 mg, about 0.5 mg to about 5 mg, about 0.5 mg to about 2.5 mg, about 0.5 mg to about 2 mg, about 0.5 mg to about 1.5 mg, or about 0.5 mg to about 1 mg.

In any of the foregoing embodiments, the composition can include pantothenic acid at about 2 mg, about 3 mg, about 4 mg, about 5 mg, about 6 mg, about 7 mg, about 8 mg, about 9 mg, about 10 mg, about 11 mg, about 12 mg, about 13 mg, about 14 mg, about 15 mg, about 16 mg, about 17 mg, about 18 mg, about 19 mg, about 20 mg, about 21 mg, about 22 mg, about 23 mg, about 24 mg, about 25 mg, about 26 mg, about 27 mg, about 28 mg, about 29 mg, about 30 mg, about 31 mg, about 32 mg, about 33 mg, about 34 mg, about 35 mg, about 36 mg, about 37 mg, about 38 mg, about 39 mg, about 40 mg, about 41 mg, about 42 mg, about 43 mg, about 44 mg, about 45 mg, about 46 mg, about 47 mg, about 48 mg, about 49 mg, about 50 mg, about 51 mg, about 52 mg, about 53 mg, about 54 mg, about 55 mg, about 56, about 57 mg, about 58 mg, about 59 mg, about 60 mg, about 61 mg, about 62 mg, about 63 mg, about 64 mg, about 65 mg, about 66 mg, about 67 mg, about 68 mg, about 69 mg, about 70 mg, about 71 mg, about 72 mg, about 73 mg, about 74 mg, about 75 mg, about 76 mg, about 77 mg, about 78 mg, about 79 mg, about 80 mg, about 81 mg, about 82 mg, about 83 mg, about 84 mg, about 85 mg, about 86 mg, about 87 mg, about 88 mg, about 89 mg, about 90 mg, about 90 mg, about 91 mg, about 92 mg, about 93 mg, about 94 mg, about 95 mg, about 96 mg, about 97 mg, about 98 mg, about 99 mg, about 100 mg, about 110 mg, about 120 mg, about 130 mg, about 140 mg, about 150 mg, about 160 mg, about 170 mg, about 180 mg, about 190 mg, about 200 mg, about 210 mg, about 220 mg, about 230 mg, about 240 mg, about 250 mg, about 260 mg, about 270 mg, about 280 mg, about 290 mg, about 300 mg, about 310 mg, about 320 mg, about 330 mg, about 340 mg, about 350 mg, about 360 mg, about 370 mg, about 380 mg, about 390 mg, about 400 mg, about 410 mg, about 420 mg, about 430 mg, about 440 mg, about 450 mg, about 460 mg, about 470 mg, about 480 mg, about 490 mg, about 500 mg, about 550 mg, about 600 mg, about 650 mg, about 700 mg, about 750 mg, about 800 mg, about 850 mg, about 900 mg, about 950 mg, about 1,000 mg, about 1,050 mg, about 1,100 mg, about 1,150 mg, about 1,200 mg, about 1,250 mg, about 1,300 mg, about 1,350 mg, about 1,400 mg, about 1,450 mg, about 1,500 mg, about 1,550 mg, about 1,600 mg, about 1,650 mg, about 1,700 mg, about 1,750 mg, or about 1,800 mg.

Pantothenic acid content values can also be expressed as ranges, for example: about 2 mg to about 1,800 mg, about 3 mg to about 1,800 mg, about 4 mg to about 1,800 mg, about 5 mg to about 1,800 mg, about 7.5 mg to about 1,800 mg, about 10 mg to about 1,800 mg, about 15 mg to about 1,800 mg, about 20 mg to about 1,800 mg, about 25 mg to about 1,800 mg, about 50 mg to about 1,800 mg, about 100 mg to about 1,800 mg, about 200 mg to about 1,800 mg, about 300 mg to about 1,800 mg, about 400 mg to about 1,800 mg, about 500 mg to about 1,800 mg, about 600 mg to about 1,800 mg, about 700 mg to about 1,800 mg, about 800 mg to about 1,800 mg, about 900 mg to about 1,800 mg, about 1,000 mg to about 1,800 mg, about 1,100 mg to about 1,800 mg, about 1,200 mg to about 1,800 mg, about 1,300 mg to about 1,800 mg, about 1,400 mg to about 1,800 mg, about 1,500 mg to about 1,800 mg, about 1,600 mg to about 1,800 mg, about 1,000 mg to about 1,800 mg, about 2 mg to about 1,750 mg, about 2 mg to about 1,700 mg, about 2 mg to about 1,600 mg, about 2 mg to about 1,500 mg, about 2 mg to about 1,400 mg, about 2 mg to about 1,300 mg, about 2 mg to about 1,200 mg, about 2 mg to about 1,100 mg, about 2 mg to about 1,000 mg, about 2 mg to about 900 mg, about 2 mg to about 800 mg, about 2 mg to about 700 mg, about 2 mg to about 600 mg, about 2 mg to about 500 mg, about 2 mg to about 400 mg, about 2 mg to about 300 mg, about 2 mg to about 200 mg, about 2 mg to about 100 mg, about 2 mg to about 75 mg, about 2 mg to about 50 mg, about 2 mg to about 25 mg, about 2 mg to about 20 mg, about 2 mg to about 15 mg, about 2 mg to about 10 mg, about 2 mg to about 7.5 mg, about 2 mg to about 5 mg, about 2 mg to about 4 mg, or about 2 mg to about 3 mg.

In any of the foregoing embodiments, the composition can include pyridoxine at about 0.75 mg, about 1 mg, about 2 mg, about 3 mg, about 4 mg, about 5 mg, about 6 mg, about 7 mg, about 8 mg, about 9 mg, about 10 mg, about 20 mg, about 30 mg, about 40 mg, about 50 mg, about 60 mg, about 70, about 80 mg, 90 mg, about 100 mg, about 150 mg, about 200 mg, about 250 mg, about 300 mg, 350 mg, about 400 mg, about 450 mg, about 500 mg, about 550 mg, about 600 mg, about 650 mg, about 700 mg, about 750 mg, about 800 mg, about 850 mg, about 900 mg, about 950 mg, 1,000 mg, about 1,500 mg, 2,000 mg, about 2,500 mg, about 3,000 mg, about 3,500 mg, about 4,000 mg, about 4,500 mg, about 5,000 mg, about 5,500 mg, about 6,000 mg, about 6,500 mg, about 7,000 mg, about 7,500 mg, about 8,000 mg, about 8,500 mg, about 9,000 mg, about 9,500 mg, about 10,000 mg, about 10,500 mg, about 11,000 mg, about 11,500 mg, about 12,000 mg, about 12,500 mg, about 13,000 mg, about 13,500 mg, about 14,000 mg, about 14,500 mg, about 15,000 mg, about 15,500 mg, 16,000 mg, about 16,500 mg, about 17,000 mg, about 17,500 mg, about 18,000 mg, about 18,500 mg, about 19,000 mg, about 19,500 mg, about 20,000 mg, about 25,000 mg, about 30,000 mg, about 35,000 mg, about 40,000 mg, or about 45,000 mg.

Pyridoxine content values can also be expressed as ranges, for example: about 0.75 mg to about 45,000 mg, about 1 mg to about 45,000 mg, about 2 mg to about 45,000 mg, about 3 mg to about 45,000 mg, about 4 mg to about 45,000 mg, about 5 mg to about 45,000 mg, about 10 mg to about 45,000 mg, about 15 mg to about 45,000 mg, about 20 mg to about 45,000 mg, about 25 mg to about 45,000 mg, about 50 mg to about 45,000 mg, about 100 mg to about 45,000 mg, about 250 mg to about 45,000 mg, about 500 mg to about 45,000 mg, about 1,000 mg to about 45,000 mg, about 2,500 mg to about 45,000 mg, about 5,000 mg to about 45,000 mg, about 7,500 mg to about 45,000 mg, about 10,000 mg to about 45,000 mg, about 15,000 mg to about 45,000 mg, about 20,000 mg to about 45,000 mg, about 25,000 mg to about 45,000 mg, about 30,000 mg to about 45,000 mg, about 35,000 mg to about 45,000 mg, about 40,000 mg to about 45,000 mg, about 0.25 mg to about 40,000 mg, about 0.25 mg to about 35,000 mg, about 0.25 mg to about 30,000 mg, about 0.25 mg to about 25,000 mg, about 0.25 mg to about 20,000 mg, about 0.25 mg to about 15,000 mg, about 0.25 mg to about 10,000 mg, about 0.25 mg to about 7,500 mg, about 0.25 mg to about 5,000 mg, about 0.25 mg to about 2,500 mg, about 0.25 mg to about 1,000 mg, about 0.25 mg to about 750 mg, about 0.25 mg to about 500 mg, about 0.25 mg to about 250 mg, about 0.25 mg to about 100 mg, about 0.25 mg to about 75 mg, about 0.25 mg to about 50 mg, about 0.25 mg to about 25 mg, about 0.25 mg to about 20 mg, about 0.25 mg to about 15 mg, about 0.25 mg to about 10 mg, about 0.25 mg to about 7.5 mg, about 0.25 mg to about 5 mg, about 0.25 mg to about 2.5 mg, about 0.25 mg to about 2 mg, about 0.25 mg to about 1 mg, or about 0.25 mg to about 0.5 mg.

In any of the foregoing embodiments, the composition can include biotin at about 0.015 mg, about 0.020 mg, about 0.025 mg, about 0.030 mg, about 0.035 mg, about 0.040 mg, about 0.045 mg, about 0.050 mg, about 0.055 mg, about 0.060 mg, about 0.065 mg, about 0.070 mg, about 0.075 mg, about 0.080 mg, about 0.085 mg, about 0.090 mg, about 0.095 mg, about 1 mg, about 2 mg, about 3 mg, about 4 mg, about 5 mg, about 6 mg, about 7 mg, about 8 mg, about 9 mg, about 10 mg, about 20 mg, about 30 mg, about 40 mg, about 50 mg, about 60 mg, about 70, about 80 mg, 90 mg, about 100 mg, about 150 mg, about 200 mg, about 250 mg, about 300 mg, 350 mg, about 400 mg, about 450 mg, about 500 mg, about 550 mg, about 600 mg, about 650 mg, about 700 mg, about 750 mg, about 800 mg, about 850 mg, about 900 mg, about 950 mg, 1,000 mg, about 1,500 mg, 2,000 mg, about 2,500 mg, about 3,000 mg, about 3,500 mg, about 4,000 mg, about 4,500 mg, about 5,000 mg, about 5,500 mg, about 6,000 mg, about 6,500 mg, about 7,000 mg, about 7,500 mg, about 8,000 mg, about 8,500 mg, about 9,000 mg, about 9,500 mg, about 10,000 mg, about 10,500 mg, about 11,000 mg, about 11,500 mg, about 12,000 mg, about 12,500 mg, about 13,000 mg, or about 13,500 mg.

Biotin content values can also be expressed as ranges, for example: about 0.015 mg to about 13,500 mg, about 0.025 mg to about 13,500 mg, about 0.05 mg to about 13,500 mg, about 0.075 mg to about 13,500 mg, about 0.1 mg to about 13,500 mg, about 0.2 mg to about 13,500 mg, about 0.5 mg to about 13,500 mg, about 0.75 mg to about 13,500 mg, about 1 mg to about 13,500 mg, about 2 mg to about 13,500 mg, about 5 mg to about 13,500 mg, about 10 mg to about 13,500 mg, about 25 mg to about 13,500 mg, about 50 mg to about 13,500 mg, about 100 mg to about 13,500 mg, about 250 mg to about 13,500 mg, about 500 mg to about 13,500 mg, about 1,000 mg to about 13,500 mg, about 2,500 mg to about 13,500 mg, about 5,000 mg to about 13,500 mg, about 7,500 mg to about 13,500 mg, about 10,000 mg to about 13,500 mg, about 11,000 mg to about 13,500 mg, about 12,000 mg to about 13,500 mg, about 13,000 mg to about 13,500 mg, about 0.015 mg to about 13,000 mg, about 0.015 mg to about 12,000 mg, about 0.015 mg to about 11,000 mg, about 0.015 mg to about 10,000 mg, about 0.015 mg to about 7,500 mg, about 0.015 mg to about 5,000 mg, about 0.015 mg to about 2,500 mg, about 0.015 mg to about 1,000 mg, about 0.015 mg to about 750 mg, about 0.015 mg to about 500 mg, about 0.015 mg to about 250 mg, about 0.015 mg to about 100 mg, about 75 mg to about 13,000 mg, about 0.015 mg to about 50 mg, about 0.015 mg to about 25 mg, about 10 mg to about 13,000 mg, about 0.015 mg to about 5 mg, about 0.015 mg to about 2.5 mg, about 0.015 mg to about 1 mg, about 0.015 mg to about 0.75 mg, about 0.015 mg to about 0.5 mg, about 0.015 mg to about 0.1 mg, about 0.015 mg to about 0.05 mg, or about 0.015 mg to about 0.025 mg.

In any of the foregoing embodiments, the composition can include niacin at about 7 mg, about 8 mg, about 9 mg, about 10 mg, about 11 mg, about 12 mg, about 13 mg, about 14 mg, about 15 mg, about 18 mg, about 19 mg, about 20 mg, about 21 mg, about 22 mg, about 23 mg, about 24 mg, about 25 mg, about 26 mg, about 27 mg, about 28 mg, about 30 mg, about 30 mg, about 31 mg, about 32 mg, about 33 mg, about 34 mg, about 35 mg, about 36 mg, about 37 mg, about 38 mg, about 39 mg, about 40 mg, about 41 mg, about 42 mg, about 43 mg, about 44 mg, about 45 mg, about 46 mg, about 47 mg, about 48 mg, about 49 mg, about 50 mg, about 51 mg, about 52 mg, about 53 mg, about 54 mg, about 55 mg, about 56, about 57 mg, about 58 mg, about 59 mg, about 60 mg, about 61 mg, about 62 mg, about 63 mg, about 64 mg, about 65 mg, about 66 mg, about 67 mg, about 68 mg, about 69 mg, about 70 mg, about 71 mg, about 72 mg, about 73 mg, about 74 mg, about 75 mg, about 76 mg, about 77 mg, about 78 mg, about 79 mg, about 80 mg, about 81 mg, about 82 mg, about 83 mg, about 84 mg, about 85 mg, about 86 mg, about 87 mg, about 88 mg, about 89 mg, about 90 mg, about 90 mg, about 91 mg, about 92 mg, about 93 mg, about 94 mg, about 95 mg, about 96 mg, about 97 mg, about 98 mg, about 99 mg, about 100 mg, about 110 mg, about 120 mg, about 130 mg, about 140 mg, about 150 mg, about 160 mg, about 170 mg, about 180 mg, about 190 mg, about 200 mg, about 210 mg, about 220 mg, about 230 mg, about 240 mg, about 250 mg, about 260 mg, about 270 mg, about 280 mg, about 290 mg, about 300 mg, about 310 mg, about 320 mg, about 330 mg, about 340 mg, about 350 mg, about 360 mg, about 370 mg, about 380 mg, about 390 mg, about 400 mg, about 410 mg, about 420 mg, about 430 mg, about 440 mg, about 450 mg, about 460 mg, about 470 mg, about 480 mg, about 490 mg, about 500 mg, about 550 mg, about 600 mg, about 650 mg, about 700 mg, about 750 mg, about 800 mg, about 850 mg, about 900 mg, about 950 mg, about 1,000 mg, about 1,050 mg, about 1,100 mg, about 1,150 mg, about 1,200 mg, about 1,250 mg, about 1,300 mg, about 1,350 mg, about 1,400 mg, about 1,450 mg, about 1,500 mg, about 1,550 mg, about 1,600 mg, about 1,650 mg, about 1,700 mg, about 1,750 mg, about 1,800 mg, about 1,850 mg, about 1,9000 mg, about 1,950 mg, about 2,000 mg, about 2,100 mg, about 2,200 mg, about 2,300 mg, about 2,400 mg, 2, 500 mg, 2,600 mg, 2,700 mg, about 2,800 mg, about 2,900 mg, about 3,000 mg, about 3,100 mg, about 3,200 mg, about 3,300 mg, about 3,400 mg, 3,500 mg, 3,600 mg, 3,700 mg, about 3,800 mg, about 3,900 mg, about 4,000 mg, about 4,100 mg, about 4,200 mg, about 4,300 mg, about 4,400 mg, 4,500 mg, 4,600 mg, 4,700 mg, about 4,800 mg, about 4,900 mg, about 5,000 mg, about 5,200 mg, about 5,300 mg, about 5,400 mg, about 5,500 mg, about 5,600 mg, about 5,700 mg, about 5,800 mg, about 5,900 mg, about 6,000 mg, about 6,100 mg, about 6,200 mg, or about 6,300 mg.

Niacin content values can also be expressed as ranges, for example: about 7 mg to about 6,300 mg, about 8 mg to about 6,300 mg, about 9 mg to about 6,300 mg, about 10 mg to about 6,300 mg, about 12.5 mg to about 6,300 mg, about 15 mg to about 6,300 mg, about 20 mg to about 6,300 mg, about 25 mg to about 6,300 mg, about 50 mg to about 6,300 mg, about 75 mg to about 6,300 mg, about 100 mg to about 6,300 mg, about 250 mg to about 6,300 mg, about 500 mg to about 6,300 mg, about 750 mg to about 6,300 mg, about 1,000 mg to about 6,300 mg, about 2,500 mg to about 6,300 mg, about 3,500 mg to about 6,300 mg, about 4,000 mg to about 6,300 mg, about 5,000 mg to about 6,300 mg, about 6,000 mg to about 6,300 mg, about 7 mg to about 6,200 mg, about 7 mg to about 6,100 mg, about 7 mg to about 6,000 mg, about 7 mg to about 5,750 mg, about 7 mg to about 5,500 mg, about 7 mg to about 5,250 mg, about 7 mg to about 5,000 mg, about 7 mg to about 4,000 mg, about 7 mg to about 3,000 mg, about 7 mg to about 2,000 mg, about 7 mg to about 1,000 mg, about 7 mg to about 900 mg, about 7 mg to about 800 mg, about 7 mg to about 700 mg, about 7 mg to about 600 mg, about 7 mg to about 500 mg, about 7 mg to about 400 mg, about 7 mg to about 300 mg, about 7 mg to about 200 mg, about 7 mg to about 100 mg, about 7 mg to about 75 mg, about 7 mg to about 50 mg, about 7 mg to about 25 mg, about 7 mg to about 15 mg, about 7 mg to about 12.5 mg, about 7 mg to about 10 mg, about 7 mg to about 9 mg, or about 7 mg to about 8 mg.

In any of the foregoing embodiments, the composition can include folic acid at about 0.2 mg, about 0.3 mg, about 0.4 mg, about 0.5 mg, about 0.6 mg, about 0.7 mg, about 0.8 mg, about 0.9 mg, about 1 mg, about 2 mg, about 3 mg, about 4 mg, about 5 mg, about 6 mg, about 7 mg, about 8 mg, about 9 mg, about 10 mg, about 11 mg, about 12 mg, about 13 mg, about 14 mg, about 15 mg, about 18 mg, about 19 mg, about 20 mg, about 21 mg, about 22 mg, about 23 mg, about 24 mg, about 25 mg, about 26 mg, about 27 mg, about 28 mg, about 30 mg, about 30 mg, about 31 mg, about 32 mg, about 33 mg, about 34 mg, about 35 mg, about 36 mg, about 37 mg, about 38 mg, about 39 mg, about 40 mg, about 41 mg, about 42 mg, about 43 mg, about 44 mg, about 45 mg, about 46 mg, about 47 mg, about 48 mg, about 49 mg, about 50 mg, about 51 mg, about 52 mg, about 53 mg, about 54 mg, about 55 mg, about 56, about 57 mg, about 58 mg, about 59 mg, about 60 mg, about 61 mg, about 62 mg, about 63 mg, about 64 mg, about 65 mg, about 66 mg, about 67 mg, about 68 mg, about 69 mg, about 70 mg, about 71 mg, about 72 mg, about 73 mg, about 74 mg, about 75 mg, about 76 mg, about 77 mg, about 78 mg, about 79 mg, about 80 mg, about 81 mg, about 82 mg, about 83 mg, about 84 mg, about 85 mg, about 86 mg, about 87 mg, about 88 mg, about 89 mg, about 90 mg, about 90 mg, about 91 mg, about 92 mg, about 93 mg, about 94 mg, about 95 mg, about 96 mg, about 97 mg, about 98 mg, about 99 mg, about 100 mg, about 110 mg, about 120 mg, about 130 mg, about 140 mg, about 150 mg, about 160 mg, about 170 mg, or about 180 mg.

Folic acid content values can also be expressed as ranges, for example: about 0.2 mg to about 180 mg, about 0.3 mg to about 180 mg, about 0.4 mg to about 180 mg, about 0.5 mg to about 180 mg, about 0.75 mg to about 180 mg, about 1 mg to about 180 mg, about 2.5 mg to about 180 mg, about 5 mg to about 180 mg, about 10 mg to about 180 mg, about 15 mg to about 180 mg, about 25 mg to about 180 mg, about 50 mg to about 180 mg, about 75 mg to about 180 mg, about 100 mg to about 180 mg, about 125 mg to about 180 mg, about 150 mg to about 180 mg, about 160 mg to about 180 mg, about 170 mg to about 180 mg, about 175 mg to about 180 mg, about 0.2 mg to about 170 mg, about 0.2 mg to about 160 mg, about 0.2 mg to about 150 mg, about 0.2 mg to about 140 mg, about 0.2 mg to about 130 mg, about 0.2 mg to about 120 mg, about 0.2 mg to about 110 mg, about 0.2 mg to about 100 mg, about 0.2 mg to about 75 mg, about 0.2 mg to about 50 mg, about 0.2 mg to about 25 mg, about 0.2 mg to about 10 mg, about 0.2 mg to about 7.5 mg, about 0.2 mg to about 5 mg, about 0.2 mg to about 4 mg, about 0.2 mg to about 3 mg, about 0.2 mg to about 2 mg, about 0.2 mg to about 1 mg, about 0.2 mg to about 0.75 mg, about 0.2 mg to about 0.5 mg, about 0.2 mg to about 0.4 mg, or about 0.2 mg to about 0.3 mg.

In any of the foregoing embodiments, the composition can include cyanocobalamin at about 0.001 mg, about 0.002 mg, about 0.003 mg, about 0.004 mg, about 0.005 mg, about 0.006 mg, about 0.007 mg, about 0.008 mg, about 0.009 mg, about 0.010 mg, about 0.011 mg, about 0.012 mg, about 0.013 mg, about 0.014 mg, about 0.015 mg, about 0.016 mg, about 0.017 mg, about 0.018 mg, about 0.019 mg, about 0.020 mg, about 0.25 mg, about 0.30 mg, about 0.35 mg, about 0.40 mg, about 0.45 mg, about 0.50 mg, about 0.55 mg, about 0.65 mg, about 0.70 mg, about 0.75 mg, about 0.80 mg, about 0.85 mg, about 0.90 mg, about 0.95 mg, about 1 mg, about 1.5 mg, about 2 mg, about 2.5 mg, about 3 mg, about 3.5 mg, about 4 mg, about 4.5 mg, about 5 mg, about 5.5 mg, about 6 mg, about 6.5 mg, about 7 mg, about 7.5 mg, about 8 mg, about 8.5 mg, about 9 mg, about 9.5 mg, 10.0 mg, about 11 mg, about 12 mg, about 13 mg, about 14 mg, about 15 mg, about 16 mg, about 17 mg, about 18 mg, about 19 mg, about 20 mg, about 21 mg, about 22 mg, about 23 mg, about 24 mg, about 25 mg, about 26 mg, about 27 mg, about 28 mg, about 29 mg, about 30 mg, about 31 mg, about 32 mg, about 33 mg, about 34 mg, about 35 mg, about 36 mg, about 37 mg, about 38 mg, about 39 mg, about 40 mg, about 41 mg, about 42 mg, about 43 mg, about 44 mg, about 45 mg, about 46 mg, about 47 mg, about 48 mg, about 49 mg, about 50 mg, about 51 mg, about 52 mg, about 53 mg, about 54 mg, about 55 mg, about 56 mg, about 57 mg, about 58 mg, about 59 mg, about 60 mg, about 61 mg, about 62 mg, about 63 mg, about 64 mg, about 65 mg, about 66 mg, about 67 mg, about 68 mg, about 69 mg, about 70 mg, about 71 mg, about 72 mg, about 73 mg, about 74 mg, about 75 mg, about 76 mg, about 77 mg, about 78 mg, about 79 mg, about 80 mg, about 81 mg, about 82 mg, about 83 mg, about 84 mg, about 85 mg, about 86 mg, about 87 mg, about 88 mg, about 89 mg, about 90 mg, about 91 mg, about 92 mg, about 93 mg, about 94 mg, about 95 mg, about 96 mg, about 97, about 98 mg, about 99 mg, about 100 mg, about 150 mg, about 200 mg, about 250 mg, about 300 mg, 350 mg, about 400 mg, about 450 mg, about 500 mg, about 510 mg, about 520 mg, about 530 mg, about 540 mg, about 550 mg, about 560 mg, about 570 mg, about 580 mg, about 590 mg, about 600 mg, about 610 mg, about 620 mg, about 630 mg, about 640 mg, about 650 mg, about 660 mg, about 670 mg, about 680 mg, about 690 mg, about 700 mg, about 710 mg, about 720 mg, about 730 mg, about 740 mg, about 750 mg, about 760 mg, about 770 mg, about 780 mg, about 790 mg, about 800 mg, about 810 mg, about 820 mg, about 830 mg, about 840 mg, about 850 mg, about 860 mg, about 870 mg, about 880 mg, about 890 mg, about 900 mg, about 1,010 mg, about 1,020 mg, about 1,030 mg, about 1,040 mg, about 1,050 mg, about 1,060 mg, about 1,070 mg, or about 1,080 mg.

Cyanocobalamin content values can also be expressed as ranges, for example: about 0.001 mg to about 1,080 mg, about 0.0025 mg to about 1,080 mg, about 0.005 mg to about 1,080 mg, about 0.0075 mg to about 1,080 mg, about 0.01 mg to about 1,080 mg, about 0.025 mg to about 1,080 mg, about 0.05 mg to about 1,080 mg, about 0.075 mg to about 1,080 mg, about 0.1 mg to about 1,080 mg, about 0.25 mg to about 1,080 mg, about 0.5 mg to about 1,080 mg, about 0.75 mg to about 1,080 mg, about 1 mg to about 1,080 mg, about 2 mg to about 1,080 mg, about 2.5 mg to about 1,080 mg, about 5 mg to about 1,080 mg, about 10 mg to about 1,080 mg, about 25 mg to about 1,080 mg, about 50 mg to about 1,080 mg, about 75 mg to about 1,080 mg, about 100 mg to about 1,080 mg, about 200 mg to about 1,080 mg, about 500 mg to about 1,080 mg, about 750 mg to about 1,080 mg, about 800 mg to about 1,080 mg, about 900 mg to about 1,080 mg, about 1,000 mg to about 1,080 mg, about 1,025 mg to about 1,080 mg, about 1,050 mg to about 1,080 mg, about 1,060 mg to about 1,080 mg, about 1,070 mg to about 1,080 mg, about 1,075 mg to about 1,080 mg, about 0.001 mg to about 1,050 mg, about 0.001 mg to about 1,000 mg, about 0.001 mg to about 900 mg, about 0.001 mg to about 800 mg, about 0.001 mg to about 700 mg, about 0.001 mg to about 600 mg, about 0.001 mg to about 500 mg, about 0.001 mg to about 400 mg, about 0.001 mg to about 300 mg, about 0.001 mg to about 200 mg, about 0.001 mg to about 100 mg, about 0.001 mg to about 75 mg, about 0.001 mg to about 50 mg, about 0.001 mg to about 25 mg, about 0.001 mg to about 10 mg, about 0.001 mg to about 5 mg, about 0.001 mg to about 2.5 mg, about 0.001 mg to about 1 mg, about 0.001 mg to about 0.5 mg, about 0.001 mg to about 0.1 mg, about 0.001 mg to about 0.05 mg, about 0.001 mg to about 0.01 mg, about 0.001 mg to about 0.0075 mg, about 0.001 mg to about 0.005 mg, about 0.001 mg to about 0.0025 mg, or about 0.001 mg to about 0.002 mg.

In any of the foregoing embodiments, the composition can include thiamin at about 0.55 mg, 0.60 mg, about 0.65 mg, 0.70 mg, about 0.75 mg, about 0.80 mg, about 0.85 mg, about 0.90 mg, about 0.95 mg, about 1 mg, about 2 mg, about 3 mg, about 4 mg, about 5 mg, about 6 mg, about 7 mg, about 8 mg, about 9 mg, about 10 mg, about 11 mg, about 12 mg, about 13 mg, about 14 mg, about 15 mg, about 18 mg, about 19 mg, about 20 mg, about 21 mg, about 22 mg, about 23 mg, about 24 mg, about 25 mg, about 26 mg, about 27 mg, about 28 mg, about 30 mg, about 30 mg, about 31 mg, about 32 mg, about 33 mg, about 34 mg, about 35 mg, about 36 mg, about 37 mg, about 38 mg, about 39 mg, about 40 mg, about 41 mg, about 42 mg, about 43 mg, about 44 mg, about 45 mg, about 46 mg, about 47 mg, about 48 mg, about 49 mg, about 50 mg, about 51 mg, about 52 mg, about 53 mg, about 54 mg, about 55 mg, about 56, about 57 mg, about 58 mg, about 59 mg, about 60 mg, about 61 mg, about 62 mg, about 63 mg, about 64 mg, about 65 mg, about 66 mg, about 67 mg, about 68 mg, about 69 mg, about 70 mg, about 71 mg, about 72 mg, about 73 mg, about 74 mg, about 75 mg, about 76 mg, about 77 mg, about 78 mg, about 79 mg, about 80 mg, about 81 mg, about 82 mg, about 83 mg, about 84 mg, about 85 mg, about 86 mg, about 87 mg, about 88 mg, about 89 mg, about 90 mg, about 90 mg, about 91 mg, about 92 mg, about 93 mg, about 94 mg, about 95 mg, about 96 mg, about 97 mg, about 98 mg, about 99 mg, about 100 mg, about 110 mg, about 120 mg, about 130 mg, about 140 mg, about 150 mg, about 160 mg, about 170 mg, about 180 mg, about 190 mg, about 200 mg, about 210 mg, about 220 mg, about 230 mg, about 240 mg, about 250 mg, about 260 mg, about 270 mg, about 280 mg, about 290 mg, about 300 mg, about 310 mg, about 320 mg, about 330 mg, about 340 mg, about 350 mg, about 360 mg, about 370 mg, about 380 mg, about 390 mg, about 400 mg, about 410 mg, about 420 mg, about 430 mg, about 440 mg, or about 450 mg.

Thiamin content values can also be expressed as ranges, for example: about 0.55 mg to about 450 mg, about 0.6 mg to about 450 mg, about 0.7 mg to about 450 mg, about 0.8 mg to about 450 mg, about 0.9 mg to about 450 mg, about 1 mg to about 450 mg, about 2.5 mg to about 450 mg, about 5 mg to about 450 mg, about 7.5 mg to about 450 mg, about 10 mg to about 450 mg, about 25 mg to about 450 mg, about 50 mg to about 450 mg, about 75 mg to about 450 mg, about 100 mg to about 450 mg, about 150 mg to about 450 mg, about 200 mg to about 450 mg, about 250 mg to about 450 mg, about 300 mg to about 450 mg, about 350 mg to about 450 mg, about 400 mg to about 450 mg, about 410 mg to about 450 mg, about 420 mg to about 450 mg, about 430 mg to about 450 mg, about 1 mg to about 450 mg, about 440 mg to about 450 mg, about 445 mg to about 450 mg, about 0.55 mg to about 425 mg, about 0.55 mg to about 400 mg, about 0.55 mg to about 375 mg, about 0.55 mg to about 350 mg, about 0.55 mg to about 325 mg, about 0.55 mg to about 300 mg, about 0.55 mg to about 200 mg, about 0.55 mg to about 100 mg, about 0.55 mg to about 75 mg, about 0.55 mg to about 50 mg, about 0.55 mg to about 25 mg, about 0.55 mg to about 10 mg, about 0.55 mg to about 5 mg, about 0.55 mg to about 2.5 mg, about 0.55 mg to about 2 mg, about 0.55 mg to about 1 mg, about 0.55 mg to about 0.9 mg, about 0.55 mg to about 0.8 mg, about 0.55 mg to about 0.7 mg, or about 0.55 mg to about 0.6 mg.

In any of the foregoing embodiments, the composition can include Vitamin A at about 0.35 mg, about 0.40 mg, about 0.45 mg, about 0.50 mg, about 0.55 mg, about 0.60 mg, about 0.65 mg, about 0.70 mg, about 0.75 mg, about 0.80 mg, about 0.85 mg, about 0.90 mg, about 0.95 mg, about 1 mg, about 2 mg, about 3 mg, about 4 mg, about 5 mg, about 6 mg, about 7 mg, about 8 mg, about 9 mg, about 10 mg, about 10.5 mg, about 11 mg, about 11.5 mg, about 12 mg, about 12.5 mg, about 13 mg, about 13.5 mg, about 14 mg, about 14.5 mg, about 15 mg, about 15.5 mg, about 16 mg, about 16.5 mg, about 17 mg, or about 17.5 mg.

Vitamin A content values can also be expressed as ranges, for example: about 0.35 mg to about 17.5 mg, about 0.4 mg to about 17.5 mg, about 0.5 mg to about 17.5 mg, about 0.6 mg to about 17.5 mg, about 0.7 mg to about 17.5 mg, about 0.8 mg to about 17.5 mg, about 0.9 mg to about 17.5 mg, about 1 mg to about 17.5 mg, about 2 mg to about 17.5 mg, about 3 mg to about 17.5 mg, about 4 mg to about 17.5 mg, about 5 mg to about 17.5 mg, about 6 mg to about 17.5 mg, about 7 mg to about 17.5 mg, about 8 mg to about 17.5 mg, about 9 mg to about 17.5 mg, about 10 mg to about 17.5 mg, about 11 mg to about 17.5 mg, about 12 mg to about 17.5 mg, about 13 mg to about 17.5 mg, about 14 mg to about 17.5 mg, about 15 mg to about 17.5 mg, about 16 mg to about 17.5 mg, about 17 mg to about 17.5 mg, about 0.35 mg to about 17 mg, about 0.35 mg to about 16 mg, about 0.35 mg to about 15 mg, about 0.35 mg to about 14 mg, about 0.35 mg to about 13 mg, about 0.35 mg to about 12 mg, about 0.35 mg to about 11 mg, about 0.35 mg to about 10 mg, about 0.35 mg to about 9 mg, about 0.35 mg to about 8 mg, about 0.35 mg to about 7 mg, about 0.35 mg to about 6 mg, about 0.35 mg to about 5 mg, about 0.35 mg to about 4 mg, about 0.35 mg to about 3 mg, about 0.35 mg to about 2 mg, about 0.35 mg to about 1 mg, about 0.35 mg to about 0.9 mg, about 0.35 mg to about 0.8 mg, about 0.35 mg to about 0.7 mg, about 0.35 mg to about 0.6 mg, about 0.35 mg to about 0.5 mg, or about 0.35 mg to about 0.4 mg.

In any of the foregoing embodiments, the composition can include Vitamin C at about 37.5 mg, about 38 mg, about 38.5 mg, about 39 mg, about 39.5 mg, about 40 mg, about 40.5 mg, about 41 mg, about 41.5 mg, about 42 mg, about 42.5 mg, about 43 mg, about 43.5 mg, about 44 mg, about 44.5 mg, about 45 mg, about 45.5 mg, about 46 mg, about 46.5 mg, about 47 mg, about 47.5 mg, about 48 mg, about 48.5 mg, about 49 mg, about 49.5 mg, about 50 mg, about 50.5 mg, about 60 mg, about 60.5 mg, about 70, about 70.5 about 80 mg, about 80.5, about 90 mg, about 90.5, about 100 mg, about 110 mg, about 111 mg, about 112 mg, about 113 mg, about 114 mg, about 115 mg, about 116 mg, about 117 mg, about 118 mg, about 119 mg, about 120 mg, about 130 mg, about 140 mg, about 150 mg, about 200 mg, about 250 mg, about 300 mg, 350 mg, about 400 mg, about 450 mg, about 500 mg, about 550 mg, about 600 mg, about 650 mg, about 700 mg, about 750 mg, about 800 mg, about 850 mg, about 900 mg, about 950 mg, 1,000 mg, about 1,500 mg, 2,000 mg, about 2,500 mg, about 3,000 mg, about 3,500 mg, about 4,000 mg, about 4,500 mg, about 5,000 mg, about 5,500 mg, about 6,000 mg, about 6,500 mg, about 7,000 mg, about 7,500 mg, about 8,000 mg, about 8,500 mg, about 9,000 mg, about 9,500 mg, about 10,000 mg, about 11,000 mg, about 12,000 mg, about 13,000 mg, about 14,000 mg, about 15,000 mg, about 16,000 mg, about 17,000 mg, about 18,000 mg, about 19,000 mg, about 20,000 mg, about 21,000 mg, about 22,000 mg, about 23,000 mg, about 24,000 mg, about 25,000 mg, about 26,000 mg, about 27,000 mg, about 28,000 mg, about 29,000 mg, about 30,000 mg, about 31,000 mg, about 32,000 mg, about 33,000 mg, about 34,000 mg, about 35,000 mg, or about 36,000 mg.

Vitamin C content values can also be expressed as ranges, for example: about 37.5 mg to about 36,000 mg, about 38 mg to about 36,000 mg, about 39 mg to about 36,000 mg, about 40 mg to about 36,000 mg, about 42.5 mg to about 36,000 mg, about 45 mg to about 36,000 mg, about 47.5 mg to about 36,000 mg, about 50 mg to about 36,000 mg, about 75 mg to about 36,000 mg, about 100 mg to about 36,000 mg, about 250 mg to about 36,000 mg, about 500 mg to about 36,000 mg, about 750 mg to about 36,000 mg, about 1,000 mg to about 36,000 mg, about 1,000 mg to about 36,000 mg, about 2,000 mg to about 36,000 mg, about 3,000 mg to about 36,000 mg, about 5,000 mg to about 36,000 mg, about 7,500 mg to about 36,000 mg, about 10,000 mg to about 36,000 mg, about 12,500 mg to about 36,000 mg, about 15,000 mg to about 36,000 mg, about 20,000 mg to about 36,000 mg, about 25,000 mg to about 36,000 mg, about 30,000 mg to about 36,000 mg, about 31,000 mg to about 36,000 mg, about 32,000 mg to about 36,000 mg, about 33,000 mg to about 36,000 mg, about 34,000 mg to about 36,000 mg, about 35,000 mg to about 36,000 mg, about 35,500 mg to about 36,000 mg, about 37.5 mg to about 35,000 mg, about 37.5 mg to about 34,000 mg, about 37.5 mg to about 32,500 mg, about 37.5 mg to about 30,000 mg, about 37.5 mg to about 25,000 mg, about 37.5 mg to about 20,000 mg, about 37.5 mg to about 15,000 mg, about 37.5 mg to about 10,000 mg, about 37.5 mg to about 7,500 mg, about 37.5 mg to about 5,000 mg, about 37.5 mg to about 2,500 mg, about 37.5 mg to about 1,000 mg, about 37.5 mg to about 900 mg, about 37.5 mg to about 800 mg, about 37.5 mg to about 700 mg, about 37.5 mg to about 600 mg, about 37.5 mg to about 500 mg, about 37.5 mg to about 400 mg, about 37.5 mg to about 300 mg, about 37.5 mg to about 200 mg, about 37.5 mg to about 100 mg, about 37.5 mg to about 75 mg, about 37.5 mg to about 50 mg, about 37.5 mg to about 47.5 mg, about 37.5 mg to about 45 mg, about 37.5 mg to about 40 mg, about 37.5 mg to about 39 mg, to about 37.5 mg to about 38 mg.

In any of the foregoing embodiments, the composition can include Vitamin D at about 0.01 mg, about 0.02 mg, about 0.03 mg, about 0.04 mg, about 0.05 mg, about 0.06 mg, about 0.07 mg, about 0.08 mg, about 0.09 mg, about 0.1 mg, about 0.5 mg, about 1 mg, about 2 mg, about 3 mg, about 4 mg, about 5 mg, about 6 mg, about 7 mg, about 8 mg, about 9 mg, about 10 mg, about 11 mg, about 12 mg, about 13 mg, about 14 mg, about 15 mg, about 18 mg, about 19 mg, about 20 mg, about 21 mg, about 22 mg, about 23 mg, about 24 mg, about 25 mg, about 26 mg, about 27 mg, about 28 mg, about 30 mg, about 30 mg, about 31 mg, about 32 mg, about 33 mg, about 34 mg, about 35 mg, about 36 mg, about 37 mg, about 38 mg, about 39 mg, about 40 mg, about 41 mg, about 42 mg, about 43 mg, about 44 mg, about 45 mg, about 46 mg, about 47 mg, about 48 mg, about 49 mg, about 50 mg, about 51 mg, about 52 mg, about 53 mg, about 54 mg, about 55 mg, about 56, about 57 mg, about 58 mg, about 59 mg, about 60 mg, about 61 mg, about 62 mg, about 63 mg, about 64 mg, about 65 mg, about 66 mg, about 67 mg, about 68 mg, about 69 mg, about 70 mg, about 71 mg, about 72 mg, about 73 mg, about 74 mg, about 75 mg, about 76 mg, about 77 mg, about 78 mg, about 79 mg, about 80 mg, about 81 mg, about 82 mg, about 83 mg, about 84 mg, about 85 mg, about 86 mg, about 87 mg, about 88 mg, about 89 mg, about 90 mg, about 90 mg, about 91 mg, about 92 mg, about 93 mg, about 94 mg, about 95 mg, about 96 mg, about 97 mg, about 98 mg, about 99 mg, about 100 mg, about 110 mg, about 120 mg, about 130 mg, about 140 mg, about 150 mg, about 160 mg, about 170 mg, about 180 mg, about 190 mg, about 200 mg, about 210 mg, about 220 mg, about 230 mg, about 240 mg, about 250 mg, about 260 mg, about 270 mg, about 280 mg, about 290 mg, about 300 mg, about 310 mg, about 320 mg, about 330 mg, about 340 mg, about 350 mg, about 360 mg, about 370 mg, about 380 mg, about 390 mg, about 400 mg, about 410 mg, about 420 mg, about 430 mg, about 440 mg, about 450 mg, about 460 mg, about 470 mg, about 480 mg, about 490 mg, about 500 mg, about 550 mg, about 600 mg, about 650 mg, about 700 mg, about 750 mg, about 800 mg, about 850 mg, about 900 mg, about 950 mg, about 1,000 mg, about 1,050 mg, about 1,100 mg, about 1,150 mg, about 1,200 mg, about 1,250 mg, about 1,300 mg, about 1,350 mg, about 1,400 mg, about 1,450 mg, about 1,500 mg, about 1,550 mg, about 1,600 mg, about 1,650 mg, about 1,700 mg, about 1,750 mg, about 1,800 mg, about 1,850 mg, about 1,900 mg, about 1,950 mg, about 2,000 mg, about 2,100 mg, about 2,200 mg, about 2,300 mg, about 2,400 mg, 2, 500 mg, 2,600 mg, 2,700 mg, about 2,800 mg, about 2,900 mg, about 3,000 mg, about 3,100 mg, about 3,200 mg, about 3,300 mg, about 3,400 mg, 3,500 mg, 3,600 mg, 3,700 mg, about 3,800 mg, about 3,900 mg, about 4,000 mg, about 4,100 mg, about 4,200 mg, about 4,300 mg, about 4,400 mg, 4,500 mg, 4,600 mg, 4,700 mg, about 4,800 mg, about 4,900 mg, about 5,000 mg, about 5,200 mg, about 5,300 mg, about 5,400 mg, about 5,500 mg, about 5,600 mg, about 5,700 mg, about 5,800 mg, about 5,900 mg, about 6,000 mg, about 6,100 mg, about 6,200 mg, or about 6,300 mg.

Vitamin D content values can also be expressed as ranges, for example: about 0.01 mg to about 6,300 mg, about 0.025 mg to about 6,300 mg, about 0.05 mg to about 6,300 mg, about 0.075 mg to about 6,300 mg, about 0.1 mg to about 6,300 mg, about 0.2 mg to about 6,300 mg, about 0.3 mg to about 6,300 mg, about 0.4 mg to about 6,300 mg, about 0.5 mg to about 6,300 mg, about 0.6 mg to about 6,300 mg, about 0.7 mg to about 6,300 mg, about 0.8 mg to about 6,300 mg, about 0.9 mg to about 6,300 mg, about 1 mg to about 6,300 mg, about 2 mg to about 6,300 mg, about 3 mg to about 6,300 mg, about 4 mg to about 6,300 mg, about 5 mg to about 6,300 mg, about 6 mg to about 6,300 mg, about 7 mg to about 6,300 mg, about 8 mg to about 6,300 mg, about 9 mg to about 6,300 mg, about 10 mg to about 6,300 mg, about 12.5 mg to about 6,300 mg, about 15 mg to about 6,300 mg, about 20 mg to about 6,300 mg, about 25 mg to about 6,300 mg, about 50 mg to about 6,300 mg, about 75 mg to about 6,300 mg, about 100 mg to about 6,300 mg, about 250 mg to about 6,300 mg, about 500 mg to about 6,300 mg, about 750 mg to about 6,300 mg, about 1,000 mg to about 6,300 mg, about 2,500 mg to about 6,300 mg, about 3,500 mg to about 6,300 mg, about 4,000 mg to about 6,300 mg, about 5,000 mg to about 6,300 mg, about 6,000 mg to about 6,300 mg, about 0.01 mg to about 6,200 mg, about 0.01 mg to about 6,100 mg, about 0.01 mg to about 6,000 mg, about 0.01 mg to about 5,750 mg, about 0.01 mg to about 5,500 mg, about 0.01 mg to about 5,250 mg, about 0.01 mg to about 5,000 mg, about 0.01 mg to about 4,000 mg, about 0.01 mg to about 3,000 mg, about 0.01 mg to about 2,000 mg, about 0.01 mg to about 1,000 mg, about 0.01 mg to about 900 mg, about 0.01 mg to about 800 mg, about 0.01 mg to about 700 mg, about 0.01 mg to about 600 mg, about 0.01 mg to about 500 mg, about 0.01 mg to about 400 mg, about 0.01 mg to about 300 mg, about 0.01 mg to about 200 mg, about 0.01 mg to about 100 mg, about 0.01 mg to about 75 mg, about 0.01 mg to about 50 mg, about 0.01 mg to about 25 mg, about 0.01 mg to about 15 mg, about 0.01 mg to about 12.5 mg, about 0.01 mg to about 10 mg, about 0.01 mg to about 9 mg, about 0.01 mg to about 8 mg, about 0.01 mg to about 7 mg, about 0.01 mg to about 6 mg, about 0.01 mg to about 5 mg, about 0.01 mg to about 4 mg, about 0.01 mg to about 3 mg, about 0.01 mg to about 2 mg, about 0.01 mg to about 1 mg, about 0.01 mg to about 0.1 mg, about 0.01 mg to about 0.075 mg, about 0.01 mg to about 0.05 mg, or about 0.01 mg to about 0.025 mg.

In any of the foregoing embodiments, the composition can include Vitamin E at about 7.5 mg, about 8.0 mg, about 8.5 mg, about 9.0 mg, about 9.5 mg, about 10 mg, 11 mg, about 12 mg, about 13 mg, about 14 mg, about 15 mg, about 18 mg, about 19 mg, about 20 mg, about 21 mg, about 22 mg, about 23 mg, about 24 mg, about 25 mg, about 26 mg, about 27 mg, about 28 mg, about 30 mg, about 30 mg, about 31 mg, about 32 mg, about 33 mg, about 34 mg, about 35 mg, about 36 mg, about 37 mg, about 38 mg, about 39 mg, about 40 mg, about 41 mg, about 42 mg, about 43 mg, about 44 mg, about 45 mg, about 46 mg, about 47 mg, about 48 mg, about 49 mg, about 50 mg, about 51 mg, about 52 mg, about 53 mg, about 54 mg, about 55 mg, about 56, about 57 mg, about 58 mg, about 59 mg, about 60 mg, about 61 mg, about 62 mg, about 63 mg, about 64 mg, about 65 mg, about 66 mg, about 67 mg, about 68 mg, about 69 mg, about 70 mg, about 71 mg, about 72 mg, about 73 mg, about 74 mg, about 75 mg, about 76 mg, about 77 mg, about 78 mg, about 79 mg, about 80 mg, about 81 mg, about 82 mg, about 83 mg, about 84 mg, about 85 mg, about 86 mg, about 87 mg, about 88 mg, about 89 mg, about 90 mg, about 90 mg, about 91 mg, about 92 mg, about 93 mg, about 94 mg, about 95 mg, about 96 mg, about 97 mg, about 98 mg, about 99 mg, about 100 mg, about 110 mg, about 120 mg, about 130 mg, about 140 mg, about 150 mg, about 160 mg, about 170 mg, about 180 mg, about 190 mg, about 200 mg, about 210 mg, about 220 mg, about 230 mg, about 240 mg, about 250 mg, about 260 mg, about 270 mg, about 280 mg, about 290 mg, about 300 mg, about 310 mg, about 320 mg, about 330 mg, about 340 mg, about 350 mg, about 360 mg, about 370 mg, about 380 mg, about 390 mg, about 400 mg, about 410 mg, about 420 mg, about 430 mg, about 440 mg, about 450 mg, about 460 mg, about 470 mg, about 480 mg, about 490 mg, about 500 mg, about 550 mg, about 600 mg, about 650 mg, about 700 mg, about 750 mg, about 800 mg, about 850 mg, about 900 mg, about 950 mg, about 1,000 mg, about 1,050 mg, about 1,100 mg, about 1,150 mg, about 1,200 mg, about 1,250 mg, about 1,300 mg, about 1,350 mg, about 1,400 mg, about 1,450 mg, about 1,500 mg, about 1,550 mg, about 1,600 mg, about 1,650 mg, about 1,700 mg, about 1,750 mg, about 1,800 mg, about 1,850 mg, about 1,9000 mg, about 1,950 mg, about 2,000 mg, about 2,100 mg, about 2,200 mg, about 2,300 mg, about 2,400 mg, 2,500 mg, 2,600 mg, 2,700 mg, about 2,800 mg, about 2,900 mg, or about 3,000 mg.

Vitamin E content values can also be expressed as ranges, for example: about 7.5 mg to about 3,000 mg, about 8 mg to about 3,000 mg, about 9 mg to about 3,000 mg, about 10 mg to about 3,000 mg, about 25 mg to about 3,000 mg, about 50 mg to about 3,000 mg, about 75 mg to about 3,000 mg, about 100 mg to about 3,000 mg, about 250 mg to about 3,000 mg, about 500 mg to about 3,000 mg, about 750 mg to about 3,000 mg, about 1,000 mg to about 3,000 mg, about 1,500 mg to about 3,000 mg, about 2,000 mg to about 3,000 mg, about 2,100 mg to about 3,000 mg, about 2,200 mg to about 3,000 mg, about 2,300 mg to about 3,000 mg, about 2,400 mg to about 3,000 mg, about 2,500 mg to about 3,000 mg, about 2,600 mg to about 3,000 mg, about 2,700 mg to about 3,000 mg, about 2,800 mg to about 3,000 mg, about 2,900 mg to about 3,000 mg, about 2,950 mg to about 3,000 mg, about 7.5 mg to about 2,900 mg, about 7.5 mg to about 2,800 mg, about 7.5 mg to about 2,700 mg, about 7.5 mg to about 2,600 mg, about 7.5 mg to about 2,500 mg, about 7.5 mg to about 2,400 mg, about 7.5 mg to about 2,300 mg, about 7.5 mg to about 2,200 mg, about 7.5 mg to about 2,100 mg, about 7.5 mg to about 2,000 mg, about 7.5 mg to about 1,750 mg, about 7.5 mg to about 1,500 mg, about 7.5 mg to about 1,250 mg, about 7.5 mg to about 1,000 mg, about 7.5 mg to about 750 mg, about 7.5 mg to about 500 mg, about 7.5 mg to about 250 mg, about 7.5 mg to about 100 mg, about 7.5 mg to about 75 mg, about 7.5 mg to about 50 mg, about 7.5 mg to about 25 mg, about 7.5 mg to about 15 mg, about 7.5 mg to about 14 mg, about 7.5 mg to about 13 mg, about 7.5 mg to about 12 mg, about 7.5 mg to about 11 mg, about 7.5 mg to about 10 mg, about 7.5 mg to about 9 mg, or about 7.5 mg to about 8 mg.

In any of the foregoing embodiments, the composition can include Vitamin K at about 0.045 mg, about 0.046 mg, about 0.047 mg, about 0.048 mg, about 0.049 mg, about 0.050 mg, about 0.051 mg, about 0.052 mg, about 0.053 mg, about 0.054 mg, about 0.055 mg, about 0.056 mg, about 0.057 mg, 0.058 mg, about 0.059 mg, about 0.060 mg, about 0.061 mg, about 0.062 mg, about 0.063 mg, about 0.064 mg, about 0.065 mg, about 0.066 mg, about 0.067 mg, 0.068 mg, about 0.069 mg, about 0.070 mg, about 0.071 mg, about 0.072 mg, about 0.073 mg, about 0.074 mg, about 0.075 mg, about 0.076 mg, about 0.077 mg, 0.078 mg, about 0.079 mg, about 0.080 mg, about 0.091 mg, about 0.092 mg, about 0.093 mg, about 0.094 mg, about 0.095 mg, about 0.096 mg, about 0.097 mg, 0.098 mg, about 0.099 mg, about 0.1 mg, about 0.2 mg, about 0.3 mg, about 0.4 mg, about 0.5 mg, about 0.6 mg, about 0.7 mg, about 0.8 mg, about 0.9 mg, about 1 mg, about 2 mg, about 3 mg, about 4 mg, about 5 mg, about 6 mg, about 7 mg, about 8 mg, about 9 mg, about 10 mg, about 20 mg, about 30 mg, about 40 mg, about 50 mg, about 60 mg, about 70, about 80 mg, 90 mg, about 100 mg, about 150 mg, about 200 mg, about 250 mg, about 300 mg, 350 mg, about 400 mg, about 450 mg, about 500 mg, about 550 mg, about 600 mg, about 650 mg, about 700 mg, about 750 mg, about 800 mg, about 850 mg, about 900 mg, about 950 mg, 1,000 mg, about 1,500 mg, 2,000 mg, about 2,500 mg, about 3,000 mg, about 3,500 mg, about 4,000 mg, about 4,500 mg, about 5,000 mg, about 5,500 mg, about 6,000 mg, about 6,500 mg, about 7,000 mg, about 7,500 mg, about 8,000 mg, about 8,500 mg, about 9,000 mg, about 9,500 mg, about 10,000 mg, about 10,500 mg, about 11,000 mg, about 11,500 mg, about 12,000 mg, about 12,500 mg, about 13,000 mg, about 13,500 mg, about 14,000 mg, about 14,500 mg, about 15,000 mg, about 15,500 mg, 16,000 mg, about 16,500 mg, about 17,000 mg, about 17,500 mg, about 18,000 mg, about 18,500 mg, about 19,000 mg, about 19,500 mg, about 20,000 mg, about 25,000 mg, about 30,000 mg, about 35,000 mg, about 40,000 mg, or about 45,000 mg.

Vitamin K content values can also be expressed as ranges, for example: about 0.045 mg to about 40,500 mg, about 0.05 mg to about 40,500 mg, about 0.075 mg to about 40,500 mg, about 0.1 mg to about 40,500 mg, about 0.25 mg to about 40,500 mg, about 0.5 mg to about 40,500 mg, about 0.75 mg to about 40,500 mg, about 1 mg to about 40,500 mg, about 12.5 mg to about 40,500 mg, about 15 mg to about 40,500 mg, about 20 mg to about 40,500 mg, about 50 mg to about 40,500 mg, about 100 mg to about 40,500 mg, about 500 mg to about 40,500 mg, about 1,000 mg to about 40,500 mg, about 2,500 mg to about 40,500 mg, about 5,000 mg to about 40,500 mg, about 7,500 mg to about 40,500 mg, about 10,000 mg to about 40,500 mg, about 12,500 mg to about 40,500 mg, about 15,000 mg to about 40,500 mg, about 17,500 mg to about 40,500 mg, about 20,000 mg to about 40,500 mg, about 22,500 mg to about 40,500 mg, about 25,000 mg to about 40,500 mg, about 27,500 mg to about 40,500 mg, about 30,000 mg to about 40,500 mg, about 31,000 mg to about 40,500 mg, about 32,000 mg to about 40,500 mg, about 33,000 mg to about 40,500 mg, about 34,000 mg to about 40,500 mg, about 35,000 mg to about 40,500 mg, about 36,000 mg to about 40,500 mg, about 37,000 mg to about 40,500 mg, about 38,000 mg to about 40,500 mg, about 39,000 mg to about 40,500 mg, about 39,250 mg to about 40,500 mg, about 39,500 mg to about 40,500 mg, about 39,750 mg to about 40,500 mg, about 40,000 mg to about 40,500 mg, about 40,100 mg to about 40,500 mg, about 40,200 mg to about 40,500 mg, about 40,300 mg to about 40,500 mg, about 40,400 mg to about 40,500 mg, about 0.045 mg to about 40,000 mg, about 0.045 mg to about 39,000 mg, about 0.045 mg to about 38,000 mg, about 0.045 mg to about 37,000 mg, about 0.045 mg to about 35,000 mg, about 0.045 mg to about 32,500 mg, about 0.045 mg to about 30,000 mg, about 0.045 mg to about 25,000 mg, about 0.045 mg to about 20,000 mg, about 0.045 mg to about 10,000 mg, about 0.045 mg to about 7,500 mg, about 0.045 mg to about 5,000 mg, about 0.045 mg to about 2,500 mg, about 0.045 mg to about 2,000 mg, about 0.045 mg to about 1,000 mg, about 0.045 mg to about 750 mg, about 0.045 mg to about 500 mg, about 0.045 mg to about 250 mg, about 0.045 mg to about 100 mg, about 0.045 mg to about 75 mg, about 0.045 mg to about 50 mg, about 0.045 mg to about 25 mg, about 0.045 mg to about 10 mg, about 0.045 mg to about 5 mg, about 0.045 mg to about 1 mg, about 0.045 mg to about 0.75 mg, about 0.045 mg to about 0.5 mg, about 0.045 mg to about 0.25 mg, about 0.045 mg to about 0.1 mg, about 0.045 mg to about 0.075 mg, or about 0.045 mg to about 0.05 mg.

In any of the foregoing embodiments, the composition can include choline at about 212.5 mg, about 213 mg, about 213.5 mg, about 214 mg, about 214.5 mg, about 215 mg, about 215.5 mg, about 216 mg, about 216.5 mg, about 217 mg, about 217.5 mg, about 218 mg, about 218.5 mg, about 219 mg, about 219.5 mg, 220 mg, about 221 mg, about 222 mg, about 223 mg, about 224 mg, about 225 mg, about 226 mg, about 227 mg, about 228 mg, about 229 mg, about 230 mg, about 240 mg, about 250, about 260 mg, about 270 mg, about 280 mg, about 290 mg, about 300 mg, 350 mg, about 400 mg, about 450 mg, about 500 mg, about 550 mg, about 600 mg, about 650 mg, about 700 mg, about 750 mg, about 800 mg, about 850 mg, about 900 mg, about 950 mg, 1,000 mg, about 1,500 mg, 2,000 mg, about 2,500 mg, about 3,000 mg, about 3,500 mg, about 4,000 mg, about 4,500 mg, about 5,000 mg, about 5,500 mg, about 6,000 mg, about 6,500 mg, about 7,000 mg, about 7,500 mg, about 8,000 mg, about 8,500 mg, about 9,000 mg, about 9,500 mg, or about 10,000 mg.

Choline content values can also be expressed as ranges, for example: about 212.5 mg to about 10,000 mg, about 212 mg to about 10,000 mg, about 213 mg to about 10,000 mg, about 214 mg to about 10,000 mg, about 215 mg to about 10,000 mg, about 220 mg to about 10,000 mg, about 225 mg to about 10,000 mg, about 250 mg to about 10,000 mg, about 275 mg to about 10,000 mg, about 300 mg to about 10,000 mg, about 400 mg to about 10,000 mg, about 500 mg to about 10,000 mg, about 750 mg to about 10,000 mg, about 1,000 mg to about 10,000 mg, about 2,000 mg to about 10,000 mg, about 3,000 mg to about 10,000 mg, about 4,000 mg to about 10,000 mg, about 5,000 mg to about 10,000 mg, about 6,000 mg to about 10,000 mg, about 7,000 mg to about 10,000 mg, about 8,000 mg to about 10,000 mg, about 9,000 mg to about 10,000 mg, about 9,100 mg to about 10,000 mg, about 9,200 mg to about 10,000 mg, about 9,300 mg to about 10,000 mg, about 9,400 mg to about 10,000 mg, about 9,500 mg to about 10,000 mg, about 9,600 mg to about 10,000 mg, about 9,700 mg to about 10,000 mg, about 9,800 mg to about 10,000 mg, about 9,900 mg to about 10,000 mg, about 9,950 mg to about 10,000 mg, about 212.5 mg to about 9,900 mg, about 212.5 mg to about 9,800 mg, about 212.5 mg to about 9,700 mg, about 212.5 mg to about 9,600 mg, about 212.5 mg to about 9,500 mg, about 212.5 mg to about 9,400 mg, about 212.5 mg to about 9,300 mg, about 212.5 mg to about 9,200 mg, about 212.5 mg to about 9,100 mg, about 212.5 mg to about 9,000 mg, about 212.5 mg to about 8,000 mg, about 212.5 mg to about 7,000 mg, about 212.5 mg to about 6,000 mg, about 212.5 mg to about 5,000 mg, about 212.5 mg to about 4,000 mg, about 212.5 mg to about 3,000 mg, about 212.5 mg to about 2,000 mg, about 212.5 mg to about 1,000 mg, about 212.5 mg to about 750 mg, about 212.5 mg to about 500 mg, about 212.5 mg to about 400 mg, about 212.5 mg to about 300 mg, about 212.5 mg to about 290 mg, about 212.5 mg to about 280 mg, about 212.5 mg to about 270 mg, about 212.5 mg to about 260 mg, about 212.5 mg to about 250 mg, about 212.5 mg to about 240 mg, about 212.5 mg to about 230 mg, about 212.5 mg to about 220 mg, about 212.5 mg to about 219 mg, about 212.5 mg to about 218 mg, about 212.5 mg to about 217 mg, about 212.5 mg to about 216 mg, about 212.5 mg to about 215 mg, about 212.5 mg to about 214 mg, or about 212.5 mg to about 213 mg.

4.2 Additives

In some embodiments, the compositions may further include sugar acids (e.g., glucuronic acid) and/or sugar alcohols (e.g., inositol). Sugar acids may be selected be from, e.g., glyceric acid, xylonic acid, gluconic acid, ascorbic acid, neuraminic acid, keto-deoxyoctulosonic acid, glucuronic acid, galacturonic acid, iduronic acid, tartaric acid, meso-galactaric acid, D-glucaric acid, or a combination thereof. Sugar alcohols may be selected from, e.g., mannitol, sorbitol, arabitol, threitol, xylitol, ribitol, galactitol, fruitol, iditol, inositol, volemitol, lactitol, malitol, or combinations thereof.

In some embodiments, amino acids may also be included in compositions, L-phenylalanine, L-leucine, L-isoleucine, L-valine, L-arginine, L-histidine, L-aspartic acid, L-glutamic acid, L-serine, L-threonine, L-asparagine, L-glutamine, L-cysteine, L-selenocysteine, glycine, L-proline, L-alanine, L-methionine, L-tyrosine, and/or L-tryptophan.

In some embodiments, the compositions can include amino acid derivatives. Such amino acid derivatives can be, e.g., N-acetyl L-tyrosine, taurine, ornithine, sarcosine, citrulline, norvaline, norleucine, α-aminobutyric acid, hydroxyproline, tert-leucine, cycloleucine, α-aminoisobutyric acid (2-methylalanine), penicillamine, homoserine, or a combination thereof. Additionally, any of various derivatives of the amino acids and amino acid derivatives mentioned above can also be included in the compositions. Examples of these amino acid derivatives include, e.g., special amino acids, non-natural amino acids, amino alcohols, and amino acids one or more of which functional groups such as terminal carbonyl group, terminal amino group, and thiol group in the case of cysteine are substituted with any one or more of various substituents. Specific examples of the substituents include, for example, an alkyl group, an acyl group, hydroxyl group, amino group, an alkylamino group, nitro group, sulfonyl group, and various protective groups. Specific examples of these amino acid derivatives include, e.g., N-γ-nitroarginine, S-nitrocysteine, S-methylcysteine, S-allylcysteine, valinamide, 2-amino-3-methyl-1-butanol (valinol), methionine sulfoxide, and S-methylcysteine sulfoxide.

Some embodiments can comprise natural flavors and/or artificial flavors. Natural flavors can be an essential oil, oleoresin, essence or extractive, protein hydrolysate, distillate, or any product of roasting, fermenting, heating or enzymolysis, which contains the flavoring constituents derived from a spice, fruit or fruit juice, vegetable or vegetable juice, edible yeast, herb, bark, bud, root, leaf or similar plant material, meat, seafood, poultry, eggs, dairy products, or fermentation products thereof, whose significant function in food is flavoring rather than nutritional. Artificial flavors are any substance, the function of which is to impart flavor, which are not derived from a spice, fruit or fruit juice, vegetable or vegetable juice, edible yeast, herb, bark, bud, root, leaf or similar plant material, meat, fish, poultry, eggs, dairy products, or fermentation products thereof. Traditional artificial flavoring such as sodium citrate, ascorbic acid, diacetyl, acetylpropinyl, acetoin, isoamyl acetate, benzaldehyde, cinnamaldehyde, ethyl propionate, methyl anthranilate, limonene, ethyl decadienoate, allyl hexanoate, ethyl maltol, ethylvanillin, methyl salicylate, manazanate, or a combination thereof may be used.

Preservatives may also be included in the compositions. For example, in some embodiments, sodium citrate, potassium sorbate, sodium benzoate, potassium benzoate, ethylenediamine tetraacetic acid (EDTA), calcium disodium EDTA, sorbic acid, sodium metabisulfate, sodium sulfite, sodium nitrite, propyl paraben, butylated hydroxyanisole, butylated hydroxytoluene, citric acid, Vitamin E, Vitamin C, and/or benzoic acid may be included in the composition.

In some embodiments, compositions may further include pH buffer(s), such as potassium phosphate, dipotassium phosphate, potassium hydrophosphate, sodium bicarbonate, sodium citrate, sodium phosphate, disodium phosphate, sodium hydrophosphate, sodium tripolyphosphate, potassium citrate, magnesium citrate, or a combination thereof.

Contemplated compositions may also include nutritional supplements including, but not limited to: magnesium carbonate, potassium phosphate dibasic, ascorbic acid, “super creatine”, coenzyme Q10 (CoQ10), citicoline, omega-3 fatty acids (such as, e.g., α-linolenic acid, eicosapentaenoic acid, docosahexaenoic acid, hexadecatrienoic acid, stearidonic acid, eicosatrienoic acid, eicosatetraenoic acid, heneicosapentaenoic acid, docosapentaenoic acid, tetracosapentaenoic acid, tetracosahexanenoic acid), omega-6 fatty acids (such as, e.g., linoleic acid, γ-linolenic acid, calendic acid, eicosadienoic acid, dihomo-γ-linolenic acid, arachidonic acid, docosadienoic acid, adrenic acid, osbond acid, tetracosatetraenoic acid, tetracosapentaenoic acid) lutein, zeaxanthin, L-theanine, fish oil, β-alanine, D-ribose, L-glutathione reduced, citrulline, L-alanyl-L-glutamine, L-hydroxyproline, or a combination thereof.

In some embodiments, the composition includes herbal supplements, e.g., ginseng, milk thistle, guarana, gingko biloba, saw palmetto, green tea, black tea, hoodia gordonii, passion flower, horny goat weed, skullcap, Echinacea, dandelion leaf, St. John's wort, green tea, chamomile, or peppermint, or an extract thereof, or a combination thereof. In some embodiments a recovery supplement for hypoxic exercise, such as L-carnitine L-tartrate, creatine, whey protein, citrulline, curcumin, β-hydroxybutyrate, or a combination thereof is included in the composition. In some embodiments, a detoxifying agent, e.g., D-glucuronolactone, milk thistle, magnesium, diatomaceous earth, glutathione, alpha lipoic acid, superoxide dismutase, N-acetyl cysteine, selenium, or a combination thereof may be included in the composition.

In some embodiments, the composition includes electrolytes, e.g., sodium chloride, sodium acetate, acidic sodium citrate, acidic sodium phosphate, sodium chloride, sodium bicarbonate, sodium bromide, sodium citrate, sodium lactate, sodium molybdate, sodium phosphate, anhydrous sodium sulphate, sodium sulphate, sodium tartrate, sodium benzoate, sodium selenite, potassium chloride, potassium acetate, potassium bicarbonate, potassium bromide, potassium citrate, potassium-D-gluconate, monobasic potassium phosphate, potassium tartrate, potassium sorbate, potassium iodide, magnesium carbonate, magnesium citrate, magnesium oxide, magnesium phosphate, magnesium chloride, calcium chloride, calcium carbonate, calcium chelate, calcium di-phosphate, calcium lactate, calcium phosphate tribasic, or a combination thereof.

In some embodiments, the composition includes colors (e.g., yellow #5, yellow #6, blue #1, blue #2, green #3, red #3, red #40, citrus red 2, orange B, caramel color, quinolone yellow (E104), carmoisine (E122), ponceau 4R (E124), patent blue V (E131), green S (E142), annatto extract, dehydrated beets, β-carotene, grape skin extract, or a combination thereof), gums (e.g., xanthan gum, gum Arabic, ester gum, guar gum, carob gum, gellen gum, cellulose gum, tara gum, or a combination thereof), and/or an emulsifier (e.g., monosodium phosphate, disodium phosphate, dipotassium phosphate, trisodium phosphate, sodium metaphosphate (sodium hexametaphosphate), sodium acid pyrophosphate, tetrasodium pyrophosphate, sodium aluminum phosphate, sodium citrate, potassium citrate, calcium citrate, sodium tartrate, sodium potassium tartrate, or a combination thereof).

In some embodiments, the composition includes a bitter additive, e.g., branched amino acids such as L-leucine, L-Valine or L-isoleucine; quinine HCl and its salts; hesperidin; sucrose octaacetate; quercetin; brucine; quassin; isohumulones; stevia extracts; saccharin; naringin; gustducin; catechin; sesquiterpene lactone; aristolochic acid; phenylthiocarbamide; propylthiouracil; flavones; noscapine; humulone; amarogentin; glucoside; limonin; amarogentin; goitrin; cynaropicrin; quassin; cycloheximide; dipeptides; any other bitter-tasting compounds from vegetables, fruits (for example, naringin and guarana), cocoa (for example, chocolate), cereals, or spices; or a combination thereof.

### 5 Food, Beverage, and Confection Applications

Below are non-limiting examples of food, beverages, and confections that may comprise the presently disclosed sweetener compositions. For example, processed fruits and fruit juices, including all commercially processed fruits, citrus, berries, and mixtures; salads; juices and juice punches; concentrates; dilutions; “ades”; and drink substitutes made therefrom may include up to about 0.25% (2,500 ppm) 1,3-propanediol, in some embodiments biologically-produced 1,3-propanediol, by weight.

Other suitable compositions include beverages such as coffee, cocoa, tea (e.g., black tea, green tea, oolong tea etc.); beverages containing milk components such as milk, coffee drinks, milk tea, fruit milk beverages, or drinkable yogurt; or kombucha.

Contemplated compositions further include dairy products including butter, yogurt, cheese, cottage cheese, sour cream, whipping cream, and frozen desserts (e.g. ice cream). For example, Greek yogurt including biologically-produced 1,3-propanediol was found to be less bitter and sweeter than without the biologically-produced 1,3-propanediol. Vanilla yogurt was less bitter and somewhat sweeter with biologically-produced 1,3-propanediol than without.

Packaged foods, such as drink mixes, dressings, dried soups, cake mix, soft drinks, popcorn, food coloring, fast foods, and breads may also include 1,3-propanediol, in some embodiments biologically-produced 1,3-propanediol, to improve taste and/or off-taste or otherwise modulate the taste of those products.

In other embodiments, the composition is a sherbet. Confections, such as cakes, crackers, biscuits, rice cakes and snacks are also contemplated. Chewing gum, hard candy, soft candy, mints, nougat, jelly beans, and other candies may also be used in the methods disclosed herein. Sauces including fruit flavored sauces, chocolate sauces and the like may also be used as the composition. Jams, including strawberry jam, raspberry jam, blackberry jam, and marmalade, for example may include biologically-produced 1,3-propanediol as a taste modulator. Biologically-produced 1,3-propanediol may improve taste and/or off-taste in condiments including soy sauce, tomato catsup, mustard, and savory sauces. Broth, canned or frozen vegetables, canned meats or seafood, processed meat products (e.g., sausage), pickles, preserves boiled, snacks (e.g., potato chips, cookies), or cereal products are all contemplated.

The food compositions may further include a food or food component consisting of one or more food additives. Further, a food composition includes human food, substances migrating to food from food-contact articles, beverages, pet food, and animal feed compositions.

A “food additive” includes any additive that can be used in a food composition. In some embodiments, an additive is of appropriate food grade, is prepared and handled as a food additive, and/or the quantity of the additive added to food does not exceed the amount reasonably required to accomplish the intended physical, nutritional, or other technical effect in food.

In addition, esters can function as many of the above noted additives. While those having skill in the art can readily determine which esters are most appropriate to provide a particularly desired function, esters used may include the esters produced, including all the appropriate conjugate mono and diesters, from 1,3-propanediol, in some embodiments biologically-produced 1,3-propanediol, using organic carboxylic acids. Some esters in particular that are produced include propanediol distearate and monostearate, propandiol dilaurate and monolaurate, propanediol dioleate and monooleate, propanediol divalerate and monovalerate, propanediol dicaprylate and monocaprylate, propanediol dimyristate and monomyristate, propanediol dipalmitate and monopalmitate, propanediol dibehenate and monobehenate, propanediol diadipate, propanediol dimaleate, propanediol dioxalate, propanediol dibenzoate, propanediol diacetate, and all mixtures thereof.

The food compositions can contain any natural additives where appropriate. Natural additives include any natural or nature-derived additives similar in composition or in function to any of the additives listed above.

While this disclosure has been particularly shown and described with reference to example embodiments thereof, it will be understood by those skilled in the art that various changes in form and details may be made therein without departing from the scope encompassed by the appended claims.

Applicants specifically incorporate the entire content of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope be limited to the specific values recited when defining a range.

The following examples are intended only for illustration and are not intended to limit the scope defined by the claims.

### EXAMPLES

### Example 1—Instruction for Flash Profiling Method* Panel Leader

1. Panelists: Recruit at least 5 and preferably 12 staff who has no allergy to the big 8 food allergens.
2. Prototypes:
a. Freshly made to same age (<1 week if possible)
b. Serve all samples at same size (>1 oz for beverages), and at same temperature (70F for foods, 40F for beverages)
3. Random coded (3-digit) and random ordered up to 5 samples
4. Keep to less than 5 samples per panel session. Less than 4 panels/day.
5. For each panelist, ship (under covid-19):
a. one set of 5 samples
b. one instruction (this page) ballot (attachment 1) and one example for how to fill in (attachment 2)
c. one bottled water (Aquafina or equivalent, no minerals added. Panelist to bring own under covid-19)
6. Tell panelists only that samples are project xyz prototypes (see allergy warning above) and please do not disclose anything else about the samples nor the project objective.
7. Describe the panelists how to blind-taste same day upon receipt according to panelists instruction below.
8. Ask panelist to please do not talk to other panelists during tasting to avoid peer, leading, order and sample bias.
9. Ask each panelist to scan/send a picture of the filled-in ballot to panel leader. Panel leader will issue a “directional analysis” (1 day) as a minimum and may include PCA (3 days) leading to conclusions and recommendations.

Instruction for Flash Profiling Method panelists:
1. Please do not eat, drink or smoke half an hour before this panel
2. Please taste this set mid-morning (9a-N) or mid-afternoon (2-4p) if possible
3. Arrange the 5 samples in front of you in any order
4. For the Flash Profiling Method ballot, fill in today's Date, your Name, and Sample (s) as “project xxx-Round x samples”
5. Taste sample one at a time, fill in any attribute you sense/and rate (see attachment 1 and 2 as example) according to the scale definitions (first row). Indicate your rating for the first sample and mark with sample code.
6. Don't forget to rate the Overall Liking (last row) based on the liking scale (1 row above).
7. Between samples, drink and gargle with water until there is no taste/aftertaste in the mouth.
8. Repeat #5, 6 and 7 above for the 4 samples one at a time
9. Scan/send a picture of your ballot to the panel leader for data analysis
10. Please stay tuned for panel leader's results, conclusions and recommendations.

Ingredients for Experiments

Cane sugar (sucrose) (Domino, premium pure cane, granulated sugar in yellow box)

HFCS55, Cargill, Lot #D050744, 3/21/22, Isoclear 55 HFCS.

Agave syrup, lidea Organic Premium Light, 75 brix, 80% fructose+15% glucose, LP160920.

RA97%, Sweet Green Field/T&L, Sweetesse, Lot 3100071, Feb. 5, 2021)

Stevia Reb M95%, by Amyris (Amyris RM95 Lot P0521-STD, Dec. 21, 2020)

Monk fruit Mogroside-V 55%, by Layn (lot #MOV03-21111901)

Sucralose syrup 25% (T&L, 25% sucralose by weight, Lot #21193011. 1 g syrup=0.25 g pure sucralose)

Erythritol (Cargill, STD Gran, 3/14/22, 3 years, batch #0022289921)

Allulose syrup 95% (T&L, 95% so 1 g=0.95 g allulose, Lot #YQ21L91243, made Sep. 1, 2021) (3.5% recommended as beverage limit in at least 1 GRN)

Tagatose (Bonumose,97%, Lot No. 19-HN9705-TAG25, Production Date Mar. 23, 2020, 250 g) (CCC=3.3 g/serving or 1.4%=can claim zero calorie)

Beverages for Spiking:

Bal Antioxidant Infusion Mango (Erythritol+stevia+0.2% natural sugars in juices)

Harmless Harvest coconut water (natural sugars)

Trop 50 No Pulp Calcium Orange Juice Drink (4.2% juice sugars, stevia leaf extract), expires 7/31/2022.

Zevia Grapefruit Citrus (stevia, possibly erythritol) (May 12, 2023/F3) 12 oz (355 ml)

Red Bull Original (11.3% sugar) (Design to show sweetness enhancement but not bitterness blocking) 8.4 oz 250 ml.

Gatorade Lemon Lime (6% sugar+dextrose)

Ripple Original (3% sugar)

### Example 2

The absolute threshold for Zemea® USP-FCC PDO in water falls between 690 ppm and 940 ppm, closer to 690 ppm. Zemea® USP-FCC PDO is tasteless at 690 ppm (FEMA, #4753, use limit for beverages). Zemea® USP-FCC Propanediol made individual ingredients and beverages less bitter and more liked. Utilized flash profile, blind tasting by N>6, as described in Example 1.

TABLE 1

| Beverage or bitter | Bitter substance | Zemea ® USP-FCC | |
|---|---|---|---|
| substance | in beverage | added | |
| Simply Grapefruit Juice | Naringin | 5 | ppm |
| Simply Orange Juice | Limonin | 940 | ppm |
| 5-Hour Energy | Caffeine, B vitamins | 690 | ppm |
| Red Bull | Caffeine | 940 | ppm |
| Caffeine | As is, pure | 690 | ppm |
| Stevia RA50 | As is, pure | 690 | ppm |

### Example 3

Six panelists experienced in the evaluation of food and beverages screened Zemea® USP-FCC at 5, 20, and 100 ppm in a reduced sugar stevia sweetened orange juice. The reduced sugar stevia sweetened orange juice containing no Zemea® USP-FCC was used as the control. The trained panelists tasted the beverage with and without Zemea® USP-FCC and discussed their perceptions of flavor indicating whether the test or the control product was sweeter, more bitter, and had a stronger overall flavor. The samples containing Zemea® USP-FCC at 5 ppm were identified as having the lowest bitterness perception and were used for paired comparison testing with a larger panel against the control containing no Zemea® USP-FCC.

Paired comparison tests for bitterness were conducted on 40 untrained panelists. The reduced sugar stevia sweetened orange juice was used as the control and was prepared with 0.0005% Zemea® USP-FCC (5 ppm) as the test variable. The products were served in 2-ounce soufflé cups labeled with 3-digit codes at refrigerated temperatures. The panelists were asked to identify the sample that was more bitter. Bottled water and unsalted crackers were available for panelists to clear their palates before and during testing.

Results

The reduced sugar stevia sweetened orange juice without Zemea® USP-FCC was statistically more bitter than the orange juice containing Zemea® USP-FCC (p-value 0.04, one-tailed). It could be hypothesized from these results that Zemea® USP-FCC is effective at making a noticeable difference in the perceived bitterness of beverages resulting in lower bitterness levels.

TABLE 2

| 40 Untrained Panelists | Stevia-Sweetened |
|---|---|
| Evaluated Each Juice | Orange Juice |
| Control Juice more bitter | 26 |
| PDO at 5 ppm more bitter | 14 |
| One-tailed “exact” p-value | 0.04 |

Adding Zemea® USP-FCC directly at 5 ppm levels to a reduced sugar orange juice matrix with stevia was statistically less bitter than a control containing no Zemea® USP-FCC (p-value). Zemea® USP-FCC as a flavor carrier is interacting with components in flavor systems and affecting the perceived bitterness of beverages. Zemea® USP-FCC at 5 ppm levels is not expected to have an organoleptic effect on its own.

### Example 4

Nine panelists experienced in the evaluation of food and beverages tasted three juices and two yogurts with and without the addition of Zemea USP-FCC propanediol. The nine panelists tasted the products and discussed their perceptions of the flavor. They indicated whether the test or control product in each pair was sweeter, more bitter, and had a stronger overall flavor.

TABLE 3
Products Tested

| | Zemea ® USP-FCC Propanediol Level % | |
|---|---|---|
| Product | Control | Test* |
| Plain Greek Yogurt | 0 | 1.0 |
| Vanilla Yogurt | 0 | 1.0 |
| Orange Juice (no pulp) | 0 | 0.1 |
| Cranberry Juice | 0 | 0.1 |
| Grapefruit Juice | 0 | 0.1 |

*Zemea ® USP-FCC Propanediol Level, Wt. %

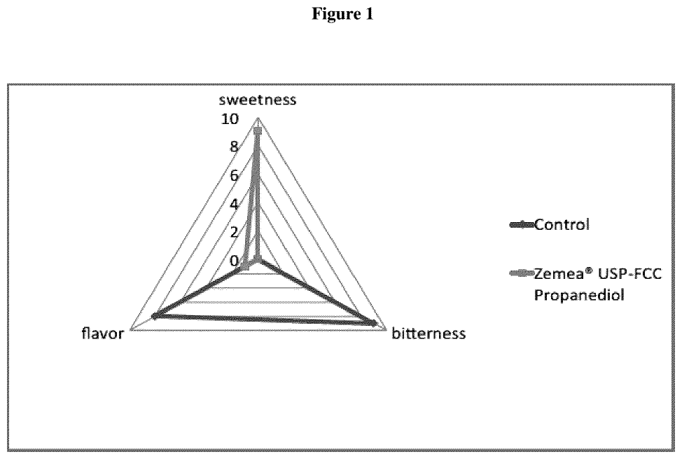

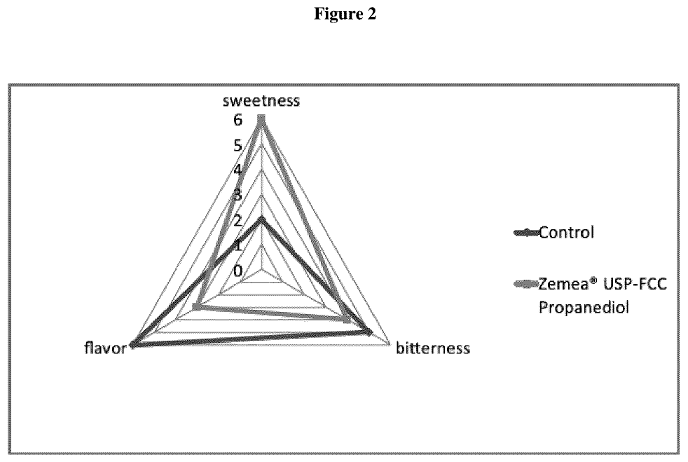

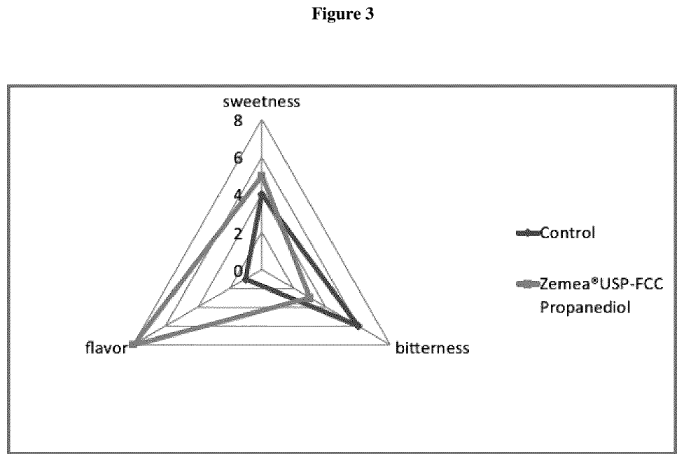

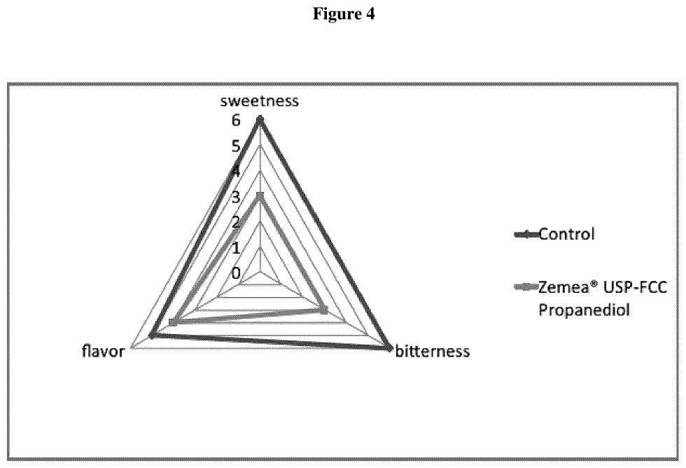

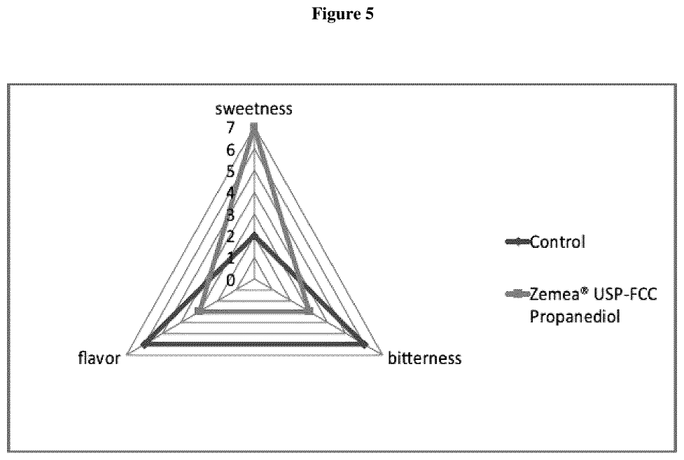

The plain Greek yogurt and grapefruit juice containing Zemea USP-FCC propanediol were less bitter and clearly sweeter than the corresponding control products. The vanilla yogurt and orange juice containing Zemea USP-FCC propanediol were less bitter and somewhat sweeter than the corresponding control products. Cranberry juice containing Zemea USP-FCC propanediol was less bitter and less sweet than the corresponding control product (FIGS. 1-5).

### Example 5

Six panelists experienced in the evaluation of food and beverages tasted sweeteners and commercial beverages with and without the addition of Zemea USP-FCC propanediol. The six panelists tasted the products and discussed their perceptions of the flavor. They indicated whether the test or control product in each pair was sweeter, less bitter, and/or less sour.

TABLE 4
Sweeteners

| | Zemea ® USP-FCC | | |
|---|---|---|---|
| Sweetener | Propanediol concentration | | Effect |
| Sucrose | 5 | ppm | Enhanced sweetness |
| High fructose corn | 5 | ppm | Enhanced sweetness |
| syrup (55%) | | | |
| Agave syrup | N/A | | N/A |
| Stevia Reb A97 | 690 | ppm | Less bitter |
| Stevia Reb M95 | 690 | ppm | Enhanced sweetness |
| Monk fruit mogroside- | 5 | ppm | Enhanced sweetness |
| V (55%) | | | |
| Sucralose | N/A | | N/A |
| Erythritol | 5 | ppm | Enhanced sweetness |
| Allulose | 5 | ppm | Enhanced sweetness |
| Tagatose | 5 | ppm | Enhanced sweetness |

TABLE 5
Commercial Beverages

| | Zemea ® USP-FCC | | |
|---|---|---|---|
| | Propanediol | | |
| Commercial Beverage | concentration | | Effect |
| Bai (stevia, | 5 | ppm | Enhanced sweetness |
| erythritol, juice sugars) | | | |
| Harmless Harvest coconut | 5 | ppm | Possible sourness |
| water (fructose, glucose, | | | blocker |
| sucrose) | | | |
| Trop50 (juice sugars, | 690 | ppm | Enhanced sweetness |
| stevia) | | | |
| Zevia Grapefruit Citrus | 690 | ppm | Enhanced sweetness |
| (stevia) | | | |
| Red Bull energy drink | 690 | ppm | Possible reduced |
| (sugar + glucose) | | | bitterness and sourness |
| Gatorade (sugar + | 940 | ppm | Reduced bitterness and |
| dextrose) | | | sourness |
| Ripple (sugars) | 940 | ppm | Enhanced sweetness |

1. A sweetener composition comprising:
(a) about 1 ppm to about 10 ppm of 1,3-propanediol; and
(b) about 18,000 ppm to about 62,000 ppm of a sweetener.

2. The sweetener composition of claim 1, wherein the sweetener is sucrose, high fructose corn syrup, erythritol, allulose, or tagatose.

3. A food, beverage, confection, or concentrate composition comprising the sweetener composition of claim 1.

4. A food, beverage, confection, or concentrate composition comprising a sweetener composition, wherein the sweetener composition consists essentially of:
(a) about 600 ppm to about 1,000 ppm of 1,3-propanediol; and
(b) about 90 ppm to about 400 ppm of a sweetener.

5. The sweetener composition of claim 4, wherein the sweetener is a Stevia sweetener.

6. The sweetener composition of claim 5, wherein the Stevia sweetener is Stevia Reb A97 or Stevia Reb M95.

7. A method of improving sweetness and/or reducing bitterness of a sweetener comprising:
(a) providing about 90 ppm to about 400 ppm of a sweetener; and
(b) adding an amount of 1,3-propanediol from about 600 ppm to about 1,000 ppm to the sweetener to form a sweetener composition consisting essentially of 90 ppm to about 400 ppm of the sweetener and from about 600 ppm to about 1,000 ppm of 1,3-propanediol, whereby said sweetener composition has improved sweetness and/or bitterness as compared to sweetener that does not include said amount of 1,3-propanediol.

8. The method of claim 7, wherein the sweetener is a Stevia sweetener.

9. The method of claim 8, wherein the Stevia sweetener is Stevia Reb A97 or Stevia Reb M95.

10. A sweetener composition produced by the method of claim 7.

11. A food, beverage, confection, or concentrate composition comprising the sweetener composition of claim 10.

12. A method of improving sweetness and/or reducing bitterness of a sweetener comprising:
(a) providing about 18,000 ppm to about 62,000 ppm of a sweetener; and
(b) adding an amount of 1,3-propanediol from about 1 ppm to about 10 ppm to the sweetener to form a sweetener composition, whereby said sweetener composition has improved sweetness and/or bitterness as compared to sweetener that does not include said amount of 1,3-propanediol.

13. The method of claim 12, wherein the sweetener is sucrose, high fructose corn syrup, erythritol, allulose, or tagatose.

14. A sweetener composition produced by the method of claim 12.

15. A food, beverage, confection, or concentrate composition comprising the sweetener composition of claim 14.
